(19) United States
(12) Patent Application Publication
(10) Pub. No.: US 2021/0381984 A1
(43) Pub. Date: Dec. 9, 2021

(54) pH Responsive Optical Nanoprobe

(71) Applicant: VALORISATION-RECHERCHE, LIMITED PARTNERSHIP, Montreal (CA)

(72) Inventors: Richard Martel, Montreal (CA); Fatemeh Natasha Shoghi, Montreal (CA); Suraj Mal, Montreal (CA); Antonella Badia, Saint-Leonard (CA)

(73) Assignee: VALORISATION-RECHERCHE, LIMITED PARTNERSHIP, Montreal (CA)

(21) Appl. No.: 17/337,657

(22) Filed: Jun. 3, 2021

(30) Foreign Application Priority Data
Jun. 4, 2020 (CA) 3.081.969

(51) Int. Cl. G01N 21/65; C01B 32/168; C01B 32/194

(52) U.S. Cl. CPC G01N 21/65; G01N 2201/06113; C01B 32/194; C01B 32/168

(57) ABSTRACT

There is provided a pH responsive optical nanoprobe comprising metallic SWCNTs or graphene coated with a transition metal M. The coated metallic SWCNTs or graphene have an absorption spectrum comprising an optical resonance, and have a Raman scattering spectrum responsive to optical excitation at said optical resonance comprising at least one pH-dependent peak having at least one of a Raman shift value and an intensity that is function of a solution pH, when the nanoprobe is in contact with a solution at said solution pH. There is also provided a method to measure the pH of a solution, by contacting the solution with the nanoprobe; illuminating the nanoprobe with an excitation light beam having a wavelength at said optical resonance, thereby generating a Raman signal from the nanoprobe according to said Raman scattering spectrum; measuring a spectral distribution of the Raman signal; and determining the pH of the solution from the spectral distribution.

### CROSS-REFERENCE TO RELATED PATENT APPLICATION

The present application claims priority from Canadian patent application no. 3.081.969 filed Jun. 4, 2020, the disclosure of which is hereby incorporated by reference in their entirety.

### TECHNICAL FIELD

The technical field generally relates to an optical nanoprobe for measuring the pH of a solution and, more specifically, to a pH responsive optical nanoprobe based on transition metal coated metallic SWCNTs and/or graphene, and a method for measuring the pH of a solution using such nanoprobe.

The present description refers to a plurality of documents, the contents of which are herein incorporated by reference in their entirety.

### BACKGROUND

Measuring proton [H⁺] concentrations in chemical or biological environments is central to a wide range of applications, such as medical diagnostics¹⁻³, environmental analysis⁴⁻⁶ and industrial processing^{7,8}. pH sensing methods have evolved over the years around potentiometric techniques in which the sensing electrode is made of either a glass electrode or an Ion-Sensitive Field-Effect Transistor (ISFET) for potential measurements in solutions. Modern pH sensors are robust, accurate and low cost, but they are limited by the macroscopic sizes of the electrodes and by errors associated with the contamination of the small electrode liquid junctions^{9,10}. As a result of these limitations, electrodeless measurements based on optical techniques such as photoluminescence spectroscopy¹¹⁻¹³ and UV-Vis absorption¹⁴⁻¹⁶ have raised interest following clear demonstrations of high precision pH measurements even on the micrometer scale.

The optical responses are, however, prone to oxidation or photobleaching and generally provide non-specific signals that can be mixed with other signals (contaminants, biomaterials, support, etc.). Furthermore, the optical pH sensor is generally poorly referenced and its performance depends on the concentration of the analyte, which is typically unknown in complex media. By relying on the relative Raman intensity of pH sensitive molecules in the protonated and deprotonated states, Surface Enhanced Raman Spectroscopy (SERS) has been applied to pH sensing to gain unambiguous signals from active molecules, thanks to the vibrational fingerprints of these pH reporters. The pH measurements remain, however, semi-quantitative due to the local nature of the hotspots, which induces large distributions of the electric field depending on the interparticle distance and geometrical configuration of the plasmonic response near the reporting molecules¹⁷. These hurdles have so far challenged the development of remote optical pH sensors that are properly referenced.

### SUMMARY

In accordance with one aspect, there is provided a pH responsive optical nanoprobe, comprising metallic Single Wall Carbon Nanotubes (SWCNTs) or graphene coated with a transition metal M, thereby defining M-SWCNTs or M-graphene, wherein the M-SWCNTs or the M-graphene have an absorption spectrum comprising an optical resonance, and have a Raman scattering spectrum responsive to optical excitation at said optical resonance comprising at least one pH-dependent peak having at least one of a Raman shift value and an intensity that is function of a solution pH, when the nanoprobe is in contact with a solution at said solution pH.

In some embodiments, the pH responsive optical nanoprobe is such that the Raman shift and/or the intensity of the at least one pH-dependent peak varies substantially linearly with said solution pH.

In some embodiments, the pH responsive optical nanoprobe is such that the Raman scattering spectrum responsive to optical excitation at said resonance extends with a G band region. In some embodiments, the G band region comprises Raman shift values between about 1450 cm⁻¹ and about 1650 cm⁻¹.

In some embodiments, the pH responsive optical nanoprobe comprises metallic SWCNTs and the at least one pH-dependent peak comprises a G₋ mode peak associated with a LO phonon branch of the metallic SWCNTs.

In some embodiments, the pH responsive optical nanoprobe comprises metallic SWCNTs and the at least one pH-dependent peak comprises a G_{f} mode peak associated with an anomaly of the band structure of the metallic SWCNTs.

In some embodiments, the pH responsive optical nanoprobe comprises metallic SWCNTs and the Raman scattering spectrum responsive to optical excitation at said optical resonance of the metallic SWCNTs further comprises at least one pH-independent peak being a G₊ mode peak, at a Raman shift substantially insensitive to the solution pH.

In accordance with another aspect, there is provided a method for preparing graphene or SWCNTs coated with transition metal-based nanoparticles, comprising:
preparing a dispersion comprising individualized graphene or SWCNTs comprising metallic SWCNTs;
adding a salt of the transition metal to the dispersion to form a mixture;
heating the mixture;
filtering or centrifuging the mixture to recover the coated graphene or SWCNTs
washing the coated graphene or SWCNTs with water to remove any unreacted metal salt;
drying the coated graphene or SWCNTs.

In some embodiments, the dispersion comprising individualized graphene or SWCNTs is prepared by sonicating an aqueous solution of the graphene or SWCNTs in the presence of a surfactant comprising sodium dodecyl sulfate (SDS), sodium cholate or a mixture thereof.

In some embodiments, the SWCNTs can have a diameter distribution of from about 0.4 nm to about 3 nm.

In some embodiments, the nanoprobe comprises graphene layers and/or graphene flakes.

In some embodiments, the metallic SWCNTs or the graphene are coated with transition metal-based nanoparticles having a particle size distribution of from about 0.9 nm to about 500 nm. In some embodiments, the transition metal-based nanoparticles have a particle size distribution of from about 0.9 to about 20 nm.

In some embodiments, the metallic SWCNTs or the graphene are coated with a thin film comprising the transition metal and the film has a thickness of from about 0.7 to about 300 nm.

In some embodiments, the metallic SWCNTs or the graphene are coated with Pt, W, Pd, Ir or Ru or any alloy thereof and/or an oxide thereof. In some embodiments, the transition metal comprises Pt.

In some embodiments, the M-SWCNTs or M-graphene are in a powder form and the powder is dispersed or encapsulated in a porous transparent material.

In accordance with another aspect, there is provided a method for measuring the pH of a solution, comprising:
contacting the solution with a pH responsive optical nanoprobe as described herein;
illuminating the pH responsive optical nanoprobe with an excitation light beam having a wavelength at said optical resonance, thereby generating a Raman signal from said pH responsive nanoprobe according to said Raman scattering spectrum;
measuring a spectral distribution and intensity of the Raman signal;
determining the pH of the solution from said spectral distribution and intensity.

Other features and advantages of the technology will be better understood upon reading of preferred embodiments thereof with reference to the appended drawings.

### BRIEF DESCRIPTION OF THE DRAWINGS

FIG. 1: TEM images of metal nanoparticles deposited on SWCNTs. a) Pt_{N}-SWCNTs, b) Pd_{N}-SWCNTs and c) Ru_{N}-SWCNTs.

FIG. 2: Comparison of Raman spectra of Si/SiO₂-supported films of (a) Pt-SWCNTs and (b) purified SWCNTs without Pt. The spectra were recorded in buffer solutions of constant ionic strength (1 M) at unitary pH increments between 1.80 (red) and 11.80 (blue) (from red to blue, pH=1.80, 2.50, 3.60, 4.30, 5.40, 6.10, 7.10, 8.50, 9.20, 10.40, and 11.80). The intensity is normalized relative to the mode maximum intensity.

FIG. 3: Spectral changes for thin films of SWCNTs (red, [symbol] ) and Pt-coated SWCNTs (blue, [symbol] ) as a function of pH obtained using constant ionic strength buffers (1 M). Energy shifts of the G₋ mode (a) and G_{f} mode (b) and normalized integrated intensity of the G₋ mode relative to mode (c). Correlation coefficients are: −0.97 (blue) and −0.94 (red) in (a), −0.99 (blue) and −0.95 (red) in (b), and 0.98 (blue and red) in (c).

FIG. 4: Energy level diagrams of the Pt/PtO (left) and O₂/H₂O (right) redox couples compared to the density of states (DOS) of metallic (left) and semiconducting (right) carbon nanotubes of small (blue) and large (red) diameters in our sample (between 1.1 nm and 1.5 nm). The arrow indicates the direction of the charge transfer reaction. The energy scale is based on a work function of 4.7 eV for the SWCNTs.

FIG. 5: Raman shifts of the G₋ mode (a) and G_{f} (b) mode and the normalized integrated intensity of the G₋ mode relative to the mode, I(G₋/G₊) (c) for uncoated SWCNTs (red, [symbol] ) and Pt-SWCNTs (blue, [symbol] ) in buffer solutions of different ionic strength. Insets show zooms of the results on Pt-SWCNT (blue, [symbol] ) along with additional data at a pH=3.54±0.01 but in different ionic strengths (I=1 M (green, [symbol] ), 0.5 M (red, [symbol] ) and 0.1 M (brown, [symbol] ).

FIG. 6: Raman shift of the G₋ mode of Pt-SWCNTs supported on three different substrates (aminopropyl-silanized, non-silanized, and parylene C-coated silicon/silicon oxide wafer) with pH in constant ionic strength (1 M) buffer solutions.

FIG. 7: (a) TEM image of the platinum nanoparticles attached to the SWCNTs of the synthesized Pt_{N}-SWCNTs pH sensor and (b) a histogram of the particle size distribution. (c) Raman spectra recorded in buffer solutions of a constant ionic strength of 1 M for unitary increments of pH. (d) Calibration curves based on the Raman shifts of the G₋ mode of Pt_{N}-SWCNTs supported on aminopropyl-silanized Si/SiO₂ versus the solution pH using 12 different buffers (blue, [symbol] ) or 3 different buffers (red, [symbol] ) solutions. The ionic strength of all the buffer solutions is 1 M.

FIG. 8: Raman spectra of a film of Pt_{N}-SWCNTs (a) film of Pd_{N}-SWCNTs (b) and a film of Ru_{N}-SWCNTs (c) on a Si/SiO₂ substrate. The spectra were recorded in buffer solutions of constant ionic strength (1 M) at unitary pH increments between 1 to 12.

FIG. 9: Schematic of the liquid cell for Raman spectroscopy. Raman spectra are collected at room temperature using a laser at a wavelength of 633 nm.

FIG. 10: Example of the mathematical deconvolution of the Raman spectrum of a thin film of Pt-coated SWCNT at pH=2.45 (blue curve—top curve). The red curves (bottom curves) are the Voigt functions used to fit the three peak components.

FIG. 11: Raman shift of the G_{f} mode and the I(G₋/G₊) ratio, i.e. the normalized integrated intensity of the G₋ mode relative to the G₊ mode, of Pt-SWCNTs in buffer solutions of constant ionic strength (1 M) with three different substrates (aminopropyl-silanized, non-silanized, and parylene C-coated silicon/silicon oxide wafer).

FIG. 12: Raman spectra at 633 nm wavelength excitation of SWCNTs on parylene-coated substrates taken before and after annealing in two different spots (a and b) and (c and d), respectively. Spectra recorded in the dry state (uncoated) are in black; acidic buffer solution in red, and basic buffer solution in blue.

FIG. 13: Variations of the Raman shift of the G_{f} mode and the I(G₋/G₊) ratio, i.e. the normalized integrated intensity of the G₋ mode relative to the G₊ mode, of Pt_{N}-SWCNTs vs pH at constant ionic strength (1 M).

FIG. 14: Calibration curves based on the Raman shifts of the G_{f} mode and the I(G₋/G₊) ratio, i.e. the normalized integrated intensity of the G₋ mode relative to the G₊ mode, of Pt_{N}-SWCNTs versus pH using solutions of 12 buffers (blue, [symbol] ) and 3 buffers (red, [symbol] ).

FIG. 15: Doping mechanism of graphene via two different redox couples in solutions of pH=1. Schematic of the electronic state of graphene near a K-point of the Brillouin zone and the electrochemical potential of the Pt/PtO (left) and O₂/H₂O (right) redox couple at different pH. The equilibrium position at pH=1 is shown for both of these redox systems in contact with graphene. The energy scale is based on a graphene work function of 4.6 eV. Blue (lowest of bottom) and red (top) regions of the Dirac cone indicate occupied and unoccupied states in graphene and a p-doping for both cases is shown.

FIG. 16: Comparison of the Raman spectra of Si/SiO₂-supported films of (a,b) uncoated graphene (u-graphene) and (c,d) platinum coated graphene (Pt-graphene). (b,d) and (a,c) show the G-band and D-band regions, respectively. The spectra were recorded in buffer solutions of constant ionic strength (1 M) at unitary pH increments between 1.60 and 11.89. Lorentzian fits to the spectra are shown.

FIG. 17: Energy shifts of the D- (a) and G-bands (b) for uncoated graphene (red, [symbol] ) and Pt-coated graphene (blue, [symbol] ) as a function of pH obtained in buffer solutions of constant ionic strength (1 M) and an excitation wavelength of λₑₓ=488 nm. The positions are determined using Lorentzian fits on each spectrum.

FIG. 18: Comparison of the Pt-graphene Raman results with pH with the Nernstian model presented. (a) Raman shift of the G-band with pH (blue data points) compared with the carrier concentration according to a fit of the results from Das et al. (black line)⁵⁶. (b) Calculation of the Fermi level position for each Raman shift taken in panel (a) superimposed with the G-band position results from this study with the pH of buffer solutions.

FIG. 19: TEM images of platinum-coated graphene. a, b: prepared without using sodium dodecyl sulfate (SDS). c, d: prepared using sodium dodecyl sulfate (SDS). Without using SDS for reaction (a, b): aggregation of large Pt island and an overall poor coverage and distribution of Pt clusters. Using SDS (c, d): improved dispersion of Pt clusters attached to the graphene flakes and no aggregate of Pt.

The invention and its advantages will become more apparent from the detailed description and examples that follow, which describe various embodiments of the invention.

### DETAILED DESCRIPTION

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

In the present description, when a broad range of numerical values is provided, any possible narrower range within the boundary of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

It is to be understood that the phraseology and terminology employed in the present description is not to be construed as limiting and are for descriptive purposes only.

Furthermore, it is to be understood that the technology can be carried out or practiced in various ways and that it can be implemented in embodiments other than the ones outlined described herein.

Meanings of technical and scientific terms used herein are to be commonly understood as by one of ordinary skill in the art to which the invention belongs, unless otherwise defined.

The present technology can be implemented in the testing or practice with methods and materials equivalent or similar to those described herein.

In accordance with one aspect, there is provided a pH responsive optical nanoprobe. The pH responsive nanoprobe can be used to measure the pH of a solution, referred to herein as the “solution pH”, when the probe is put in contact with this solution.

The pH responsive optical nanoprobe comprises an electrically conductive nanomaterial as a core nanomaterial, which is coated with a transition metal M.

In some implementations, the pH responsive optical nanoprobe can comprise metallic Single Wall Carbon Nanotubes (SWCNTs) which are coated with a transition metal M, thereby defining a transition metal-SWCNTs system, referred to as “M-SWCNTs” in the following description.

Although the following description will describe a pH responsive optical nanoprobe comprising metallic SWCNTs, it is worth mentioning that the pH responsive optical nanoprobe is not limited to using SWCNTs as the core nanomaterial in the nanoprobe. Indeed, in some implementations, the pH responsive optical nanoprobe can include graphene instead of, or combined with, the SWCNTs. Hence, in some implementations, the pH responsive optical nanoprobe can include graphene coated with a transition metal M, which will be referred to as “M-graphene” in the following description. In some implementations, the graphene can be in the form of layers, flakes, platelets and/or powder.

M-SWCNTs and M-graphene are characterized by an absorption spectrum which includes an optical resonance. As known to those skilled in the art, an optical resonance refers to the wavelength of light photons which can be inelastically scattered by a molecule, leading to absorption of the incoming photon. The resonant Raman process is promoted at the optical resonance and leads to the emission of a photon of lesser energy (Stokes scattering) or higher energy (anti-Stokes scattering), the energy difference corresponding to a vibrational state of the molecule. In accordance with one aspect, the M-SWCNTs and M-graphene have a Raman scattering spectrum responsive to optical excitation at the optical resonance which includes at least one pH-dependent peak.

In some implementations, the pH-dependent peak is at a Raman shift that is function of the solution pH, when the nanoprobe is in contact with a solution at this solution pH.

As known to those skilled in the art, the expression “Raman shift” refers to the spectral distance between the wavelength of the absorbed photon and that of the photon emitted as a result of Raman scattering. Advantageously, in some implementations the Raman shift of the at least one pH-dependent peak varies substantially linearly with the solution pH.

In some implementations, the Raman scattering spectrum responsive to optical excitation at the optical resonance extends with the G-band region, which in generally understood to correspond to Raman shift values between about 1450 cm⁻¹ and about 1660 cm⁻¹.

In some implementations, the pH-dependent has an intensity that is function of the solution pH, when the nanoprobe is in contact with a solution at this solution pH. The integrated intensity of the Raman response of the M-SWCNTs or M-graphene may therefore be used by itself or in combination with the spectral displacement of the pH-dependent peak to determine the solution pH.

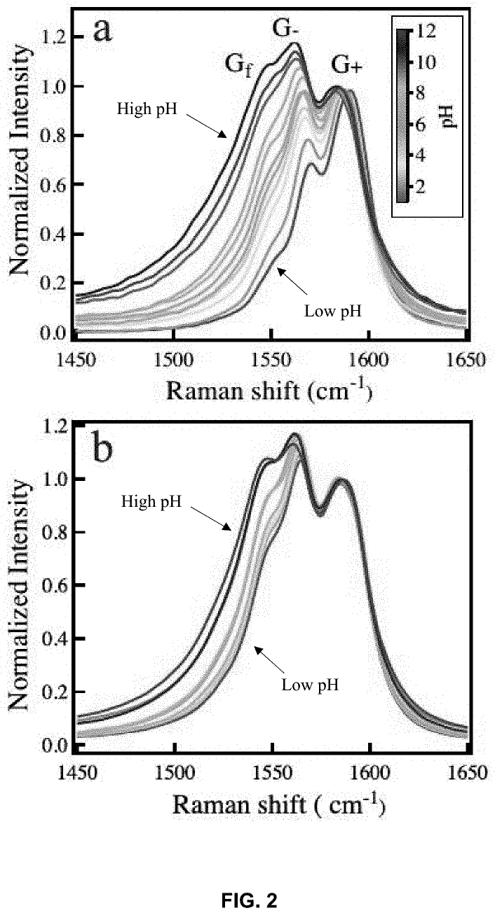

By way of example, FIG. 2a shows the Raman scattering spectrum of Pt-SWCNTs in response to optically excitation by a laser beam at a wavelength of λₑₓ=632 nm, corresponding to an optical resonance of the metallic nanotubes in the sample between 600 nm and 800 nm. The nanoprobes were exposed to solutions of various solution pH values between 1.80 and 11.80. Three peaks can be observed in the G band. The first peak at the highest Raman shift, labeled G₊ mode, is clearly the least affected by pH, and can be deemed a pH-independent peak at a Raman shift substantially insensitive to the solution pH. This mode is associated with the TO phonon branch with movements of atoms along the nanotube axis. Because its position and intensity vary little with pH, the G₊ mode can serve as a spectral reference point for normalization. By contrast, the second and third peaks located below the G₊ mode evolve with pH, and can therefore be said to constitute pH-dependent peaks. The peak labeled G₋ mode, which is right below the G₊ mode, is ascribed to LO phonons with a component along the circumferential direction of the metallic nanotube. This mode has been reported to undergo a blue shift upon doping, a behavior ascribed to strong electron-phonon coupling in SWCNTs, which affects the lattice parameters (i.e., C—C bond length) and renormalize the phonon energy. Because of its peculiar line shape (broad and asymmetrical), the low energy peak at around 1548 cm⁻¹ is called the Fano mode (labeled here as G_{f}). Due to a Kohn anomaly in the nanotube band structure, the position and shape of the G_{f} mode depend strongly on charge density; mode broadening and softening are maximum when the doping state of the metallic SWCNT is near charge neutrality.

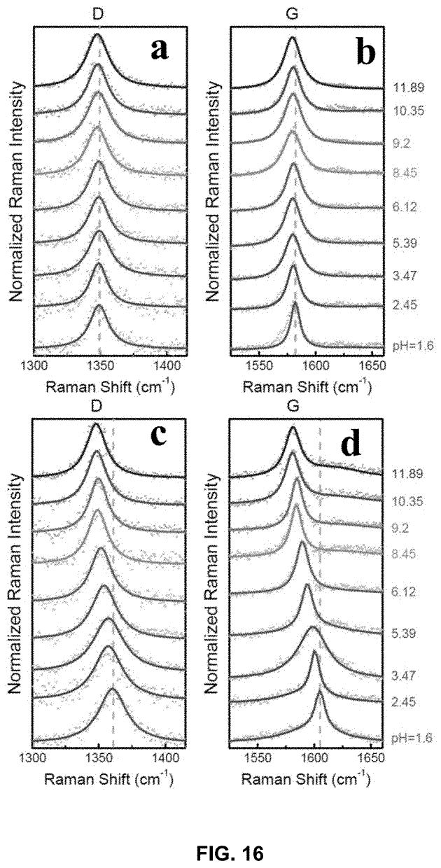

By way of another example, FIG. 16 shows the Raman scattering spectrum of Pt-graphene in response to optically excitation by a laser beam at a wavelength of λₑₓ=488 nm, corresponding to an optical resonance of graphene in the sample. The nanoprobes were exposed to solutions of various solution pH values between 1.6 and 11.9. In particular, FIG. 16 provides a comparison of the Raman spectra of Si/SiO₂-supported films of (a,b) uncoated graphene (u-graphene) and (c,d) platinum coated graphene (Pt-graphene). (b,d) and (a,c) show the G-band (1525-1660 cm⁻¹) and D-band (1300-1425 cm⁻¹) regions, respectively. The spectra were recorded in buffer solutions of constant ionic strength (1 M) at unitary pH increments between 1.60 and 11.89. Lorentzian fits to the spectra are shown. At first sight, the results show strong shifts of the G bands with pH for the Pt-graphene sample, compared to the very slight shift sown for u-graphene. Further experiments performed at λₑₓ=514 nm (not shown here) gave the same results except that the signal to noise (S/N) ratio are much lower due to a reduction of the optical resonance with increasing wavelength. Graphene has also a Raman cross section that is one thousand times lower than that of carbon nanotubes due to a broad optical resonance in the near IR to visible regions of the spectrum. It will however be readily understood by one skilled in the art that, in some implementations, the Raman shift or intensity change as a function of pH observed in the D-band for Pt-graphene can be sufficient to be used in the context of a pH responsive optical nanoprobe as described herein.

The G-band is a first-order scattering process associated with degenerated phonon modes (iTO and LO) at the Γ point (i.e., at the center of the Brillouin zone). These phonons consist of in-plane vibrations of the sp²-hybridized carbon lattice. In contrast, the D-band and the 2D-band are second-order processes. The D-mode involves light scattering with two iTO phonons near the K point of opposite, yet high, momenta so that the scattering process takes place across the Brillouin zone. All of these modes undergo a blue shift with increasing doping and this surprising behavior has been extensively discussed in the literature. As seen in FIG. 16 for Pt-graphene, a change in pH from 1 to 12 induces a gradual red shift of the D-band and G-band of about 12 cm⁻¹ and 25 cm⁻¹, respectively, whereas the shift of both is generally less than 1 cm⁻¹ for u-graphene. A pH-dependent signature is also noted (not shown here) for the 2D band between 2630 and 2700 cm⁻¹. As per the results with the metallic nanotubes, the shifting trend observed here is consistent with a charge transfer reaction at the surface of the graphene with the protons in the buffer solution. Considering that doping induces a blue shift of the Raman bands, it is possible to deduce that the Pt-graphene appears strongly p-doped at pH of about 1 and its doping level decreases significantly with increasing pH across the whole range. At pH 12, the Raman shift of the G-band is at 1583 cm⁻¹, which indicates that graphene is nearly undoped at this point. By contrast, the G-band spectra for u-graphene show a slightly blue shifted position at pH=1 near to ˜1580 cm⁻¹, i.e., weak p-doping, but the graphene remains nearly undoped across the full pH range investigated. The absence of a pH dependency of the Raman bands of u-graphene is not surprising and consistent with earlier results by Schoenberg's group using graphene transistors⁶⁰. The direct comparison between u-graphene and Pt-graphene illustrates well the impact of the surface functionalization with Pt in this doping process.

As mentioned above, in some implementations, the pH responsive optical nanoprobe can be based on a transition metal-SWCNTs system including SWCNTs coated with a transition metal M. The SWCNTs include metallic SWCNTs as species that are active for pH sensing.

SWCNTs are said to be “metallic” when the graphene sheet forming the carbon nanotubes presents a particular roll orientation, which is defined by the lattice parameter n, m. The metallic SWCNTs are electrically conducting. Armchair SWCNTs generally exhibit metallic properties. Zigzag and Chiral SWCNTs nanotubes can be metallic depending upon the difference between the n and m parameters. In some implementations, the metallic SWCNTs can have an electrical conductivity without doping from about 1000 S/cm to more than 10⁶ S/cm, depending on defect density.

In some implementations, the pH responsive optical nanoprobe can include a mixture of metallic and semiconducting SWCNT species. The ratio of metallic to semiconducting SWCNTs can for example be at least 1:2. In some implementations, the content of metallic SWCNTs can be increased to reach a percentage of at least 99%. In other implementations, the content of metallic SWCNTs can be about 33% to 100%.

It is to be noted, that in some implementations, the pH responsive optical nanoprobe can include multi-walled nanotubes (MWCNTs), for example double-walled nanotubes (DWCNTs), to some extent, generally as impurities. For instance, MWCNTs and more particularly DWCNTs, which can also be coated with the transition metal, can be present in addition to the SWCNTs and/or graphene in the pH responsive optical nanoprobe.

In some implementations, the SWCNTs can have a diameter distribution varying from about 0.4 nm to about 3 nm. For instance, the diameter distribution of the SWCNTs can be from about 0.4 nm to about 1.5 nm, or from about 0.9 nm to about 2.0 nm or from about 1.0 nm to about 2.5 nm. In other implementations, the SWCNTS can be characterized by a diameter distribution ranging for example from about 1.0 nm to about 1.5 nm. The length of the SWCNTs can vary. In some implementations, the length of the SWCNTs can be from about 0.2 μm to about 500 μm, or from about 1 μm to about 500 μm, or from about 0.2 μm to about 5 μm, or from about 0.5 μm to about 5 μm, or from about 0.2 μm to about 1 μm, or about 0.2 μm or below, or from about 50 nm to about 0.2 μm.

As mentioned above, in other implementations, the pH responsive optical nanoprobe can be based on a transition metal-graphene system including graphene coated with a transition metal M. Graphene is electrically conducting and can act as the species that is active for pH sensing. In some implementations, graphene can have an electrical conductivity without doping from about 1 S/cm to more than 10⁶ S/cm, or from about 100 S/cm to about 10⁴ S/cm or from about 20 S/cm to about 10³ S/cm depending on defect density, geometry and the structure of the film.

In some implementations, graphene can be in the form of a layer or in the form of flakes (one can also refer to graphene platelets). When the graphene is in the form of flakes, these flakes can themselves be staked in the form of layers. For both the layers and flakes, the graphene can be composed of a single layer or multilayers. The multilayers can have between 2 and 20 layers, or between 4 and 15 layers, or between 4 and 7 layers, or between 2 and 4 layers. In some implementations, the graphene can comprise layers having sizes ranging from about 200 nm to about 20 mm, or from about 1 μm to 300 μm. In some implementations, the graphene can comprise flakes having sizes up to about 500 nm, or up to about 400 nm, or up to about 300 nm, or up to about 200 nm, or up to about 100 nm, or up to about 50 nm. In some implementations, the size of the nanoflakes can be from about 50 nm to about 300 nm. In some other implementations, the size of the nanoflakes can be from about 10 nm to about 100 nm. When mentioning the size of the layers or flakes, one refers to the lateral dimensions and the values are average values. Hence, the graphene layers and/or flakes can include material having dimensions outside the mentioned ranges.

The SWCNTs and/or graphene of the pH responsive optical nanoprobe are coated with a transition metal M. In some implementations, the transition metal can include Pt, W, Pd, Ir, Ru or any mixture thereof. In other implementations, the coating can include Pt, W, Pd, Ir, Ru or any alloy thereof. The use of a mixture of transition metals can be used to adjust the potential window. The transition metal can be coated onto the SWCNTs and/or graphene as the element (or an alloy of the elements), and also in an oxide form. When referring to “transition metal”, “transition metal M” or simply “M” (including in “M-SWCNTs” and “M-graphene”), one thus refers to the element M (or an alloy thereof), an oxide of M or a mixture of the element an oxide. Hence, in some implementations, platinum oxide (e.g., PtO), tungsten oxide (e.g., WO₂), palladium oxide (e.g., PdO), iridium oxide (e.g., IrO₂) or ruthenium oxide (e.g., Ru₂O₅) can be present on the SWCNTs and/or graphene. In a preferred embodiment, the SWCNTs and/or graphene can be coated with Pt as the transitional metal, i.e, as Pt and/or PtO. However, any transition metal (element and/or oxide) could be envisioned for being coupled with the SWCNTs and/or graphene.

The transition metal M can be coated or deposited in the form of a film or in the form of nanoparticles depending on the method used to coat the SWCNTs or graphene. Such methods will be described in more detail below. Hence, when reference is made to “coated” or “coating” with respect to the SWCNTs or graphene, one can refer to SWCNTs or graphene that are fully coated or partially coated. One can also refer to “doped” SWCNTs or graphene.

In the case where the SWCNTs or the graphene are coated with a film of the transition metal, the film thickness can preferably be of from about 0.7 nm to about 300 nm. In some implementations, the SWCNTs or the graphene can be coated with a film of the transition metal having a thickness ranging from about 0.7 nm to about 250 nm, or from about 0.7 nm to about 200 nm, or from about 0.7 nm to about 150 nm, or from about 0.7 nm to about 100 nm, or from about 0.7 nm to about 50 nm, or from about 0.7 nm to about 40 nm, or from about 0.7 nm to about 30 nm, or from about 0.7 nm to about 30 nm, or from about 0.7 nm to about 20 nm, or from about 0.7 nm to about 10 nm.

As mentioned above, the SWCNTs or the graphene can be coated with transition metal nanoparticles instead of a film. In some implementations, the transition metal nanoparticles can have a particle size distribution of from about 0.9 nm to about 500 nm. In other implementations, the particle size distribution of the nanoparticles can be from about 0.9 nm to about 400 nm, or from about 0.9 nm to about 300 nm, from about 0.9 nm to about 200 nm, or from about 0.9 nm to about 100 nm, or from about 0.9 nm to about 50 nm, or from about 0.9 nm to about 40 nm, or from about 0.9 nm to about 30 nm, or from about 0.9 nm to about 20 nm, or of from about 0.9 to about 10 nm. In other implementations, the particle size distribution of the nanoparticles can be from about 2 nm to about 10 nm or from about 2 nm to about 5 nm.

The content of the transition metal coated onto the SWCNTs or the graphene can vary. In some implementations, independently of whether the transition metal is coated as a film or in the form of nanoparticles, the content in transition metal of the M-SWCNTs or the M-graphene can be from about 0.1 wt % to about 99.999 wt %. In other implementations, the transition metal can represent about 30 wt % to about 50 wt % of the M-SWCNTs and the SWCNTs can represent about 50 wt % to about 70 wt % of the M-SWCNTs. In further implementations, the transition metal can represent about 30 wt % to about 50 wt % of the M-graphene and the graphene can represent about 50 wt % to about 70 wt % of the M-graphene.

Depending on the context of its application, the pH responsive optical nanoprobe can have different designs, as long as the solution to be tested can be in contact with the M-SWCNTs or M-graphene during the pH measurement. Moreover, the nanoprobe design should allow the excitation light beam to reach the M-SWCNTs or M-graphene. For these reasons, the M-SWCNTs, generally in the form of a powder, and/or the M-graphene, which can be in the form of flakes, platelets or powder, can be immobilized on a transparent supporting surface or encapsulated in a porous transparent material. For instance, the M-SWCNTs and/or M-graphene can be immobilized on a Si/SiO₂ substrate. In other implementations, the M-SWCNTs and/or M-graphene can be dispersed or encapsulated in a porous transparent material comprising for instance porous glass or porous glass-ceramic forming a composite media that can be electrically insulating.

The pH responsive optical nanoprobe as described herein can be used to measure the pH of various type of solutions including aqueous solutions but could also be used in solutions containing organic solvents miscible or immiscible to water. Preferably, the pH responsive optical nanoprobe is used to measure the pH of a solution containing water.

Method for Preparing the Transition Metal Coated SWCNTs or Graphene

The transition metal coated SWCNTs or graphene used in the pH responsive optical nanoprobe as described above can be prepared using several techniques. For instance, an electron beam (e-beam) evaporator deposition can be used where the transition metal is deposited on a mat of entangled SWCNTs or graphene supported on an oxidized silicon wafer according to known techniques. Alternatively, one can use a one pot preparation where metal nanoparticles are grown in solution. This one pot method involves i) ultrasonically dispersing the SWCNTs or graphene in deionized water mixed with an alcohol (e.g., 2-propanol), ii) adding the metal salt to the solution, and iii) heating up the mixture (e.g., to about 80° C.) in the presence of a reducing agent (e.g., sodium borohydride, NaBH₄) under vigorous agitation. Then, the mixture is filtered, the M-SWCNTs or M-graphene washed and dried under vacuum (e.g., at about 120° C. for about 4 hours).

Another method for preparing the transition metal coated SWCNTs or graphene used in the pH responsive optical nanoprobe, which was developed by the present inventors, will now be described. This method involves the synthesis of transition metal nanoparticles deposited on SWCNTs or graphene using a novel wet chemistry approach.

In some implementations, the novel method first involves obtaining a dispersion of the SWCNTs or graphene in which the nanostructures are individualized, to promote coating of the transition metal thereto in the next steps. Obtention of the individualized carbon nanostructures in solution can be performed in different ways. For instance, one can use a surfactant or a polymer to wrap the SWCNTs or graphene, combined with sonication, to allow individualization in solution and obtaining a homogenous dispersion. Examples of polymers that can be used to wrap the carbon nanostructures can include poly(9,9-di-n-octylfluorene) (PFO), poly(p-phenylenevinylene) derivative (PPV) and polyethylene glycol derivatives (PEG), just to name a few. A person skilled in the art would be able to select a suitable polymer. In an alternative method, individualization of the carbon nanostructures and obtention of a homogenous dispersion can be performed by using graphene or SWCNTs, which are functionalized with polar groups, such as —COOH, —SH, —OH, —NH₃, R—COOH, R—NH₂, R-Hal, with R being a divalent hydrocarbon group such as alkylenyl, alkenylenyl, alkynylenyl or a divalent aromatic group, and Hal being F, Cl, Br or I (e.g., —C₆H₄—Br), to name a few examples. In some implementations, the alkylenyl group can include from 1 to 20 carbon atoms, the alkenylenyl group can include from 2 to 20 carbon atoms, the alkynylenyl group can include from 3 to 20 carbon atoms and the aromatic group can include from 5 or 12 carbon atoms, e.g., 5 or 6 carbon atoms. In some implementations, R can represent CₙHₘ with n being an integer from 1 to 20 and m an integer ranging 2 to 40.

As mentioned above, in some implementations, the obtention of individualized carbon nanostructures in solution can include the preparation of an aqueous dispersion of surfactant wrapped SWCNTs or graphene. The SWCNTs, which comprise metallic SWCNTs, can optionally also include semiconducting SWCNTs. Graphene can be in any form as described above. The preparation of the dispersion can be performed by first mixing the SWCNTs or graphene with a surfactant aqueous solution thereby obtaining surfactant wrapped SWCNTs or graphene and then sonicating the aqueous solution to ensure maximum de-agglomeration and dispersion of the nanotubes or graphene in the solution. The surfactant, which is wrapping the SWCNTs or graphene, can be any surfactant commonly used for enhancing dispersibility of the SWCNTs or graphene in water. In some implementations, the surfactant can comprise an anionic surfactant such as an organosulfate surfactant. For instance, the surfactant can be a long chain organosulfate (e.g., with at least 10 carbon atoms). Examples of surfactants can include sodium dodecyl sulfate (SDS), sodium cholate or a mixture thereof. The concentration of surfactant in the aqueous solution used to wrap the nanotubes or graphene can vary depending on the surfactant. In some implementations, the concentration in surfactant in the aqueous solution can be from about 0.01 to about 0.3 mol/l, preferably about 0.05 mol/l, or alternatively from about 0.1% w/v to about 4% w/v, preferably from about 1% to about 2% w/v. The concentration of SWCNTs or graphene in the surfactant aqueous solution can vary for example from about 0.1 μg/ml to about 1000 μg/ml. In some implementations, SWCNTs are used and the concentration of the wrapped SWCNTs in the surfactant aqueous solution can vary from about 0.1 μg/ml to about 100 μg/ml, or from about 0.1 μg/ml to about 50 μg/ml, or from about 0.1 μg/ml to about 40 μg/ml, or from about 0.1 μg/ml to about 30 μg/ml, or from about 0.1 μg/ml to about 20 μg/ml, or from about 0.1 μg/ml to about 15 μg/ml, or from about 1 μg/ml to about 15 μg/ml, or from about 5 μg/ml to about 15 μg/ml. In some implementations, graphene flakes are used and the concentration of the wrapped graphene flakes in the surfactant aqueous solution can vary from about 0.1 μg/ml to about 500 μg/ml, from about 10 μg/ml to about 1 mg/ml preferably about 50 μg/ml.

To further enhance dispersibility and individualization of the wrapped or functionalized SWCNTs or graphene, the solution can be sonicated. The intensity and time of the sonication can be adapted to ensure a proper dispersion of the SWCNTs or graphene. In some implementations, the wrapped SWCNTs or graphene can be sonicated for about 1 min to about 200 min. In other implementations, the sonication time can be less than about 150 min, or less than about 100 min, or less than about 50 min, or less than about 40 min, or less than about 30 min, or less than about 20 min.

Once the SWCNTs or graphene are dispersed in solution (e.g., aqueous solution), after sonication, a transition metal salt can be added to the solution. Many different types of salts of the transition metal can be used, and a skilled artisan will be able to select a salt of the desired transition salt. In some implementations, the transition metal salt can include H₂PtCl₆, PtCl₂, PtBr₂, PtCl₃, PtBr₃, PtI₂, PtSO₄, PtCl₂(NH₄)₂, [Pt(NH₃)₂]Cl₄ or any mixture thereof. In other implementations, the transition metal salt can be selected from the group consisting of PdCl₂, PdBr₂, PdI₂, [Pd(NH₃)₄]Br₂, [Pd(NH₃)₄]Cl₂, Pd(SO₄) and any mixture thereof. In other implementations, the transition metal salt can be selected from the group consisting of RuCl₂, RuI₂, [Ru(NH₃)₆]Cl₂ and any mixture thereof. In further implementations, the transition metal salt can be selected from the group consisting of WCl₄, WCl₆ and any mixture thereof. In further implementations, the transition metal salt can be selected from the group consisting of IrCl₂, IrCl₄ and any mixture thereof. In some implementations, a mixture of salts of different transition metals can be used. In some implementations, the transition metal salt can include H₂PtCl₆, e.g., in the form of a hydrate (i.e., chloroplatinic acid hydrate).

The transition metal salt can be added to the sonicated aqueous solution including the SWCNTs or graphene at different ratios. In some implementations, where SWCNTs are used, the transition metal salt can be added to the sonicated solution in a weight ratio nanotube:metal of from about 1:500 to about 1:10. In other implementations, the transition metal salt can be added to the sonicated solution in a ratio of from about 1:400 to about 1:10, or from about 1:300 to about 1:10, or from about 1:200 to about 1:10, or from about 1:100 to about 1:10, or from about 1:75 to about 1:10, or from about 1:75 to about 1:25. In some implementations, where graphene flakes are used, the transition metal salt can be added to the sonicated solution in a weight ratio graphene:metal of from about 1:500 to about 10:1. In other implementations, the weight ratio graphene:metal can be from about 1:400 to about 10:1, or from about 1:300 to about 10:1, or from about 1:200 to about 10:1, or from about 1:100 to about 10:1, or from about 1:10 to about 10:1, or from about 1:200 to about 5:1, or from about 1:100 to about 5:1, or from about 1:50 to about 5:1. In some implementations, the weight ratio graphene:metal can be from about 1:100 to about 1:2, or from about 1:50 to about 1:2, or from about 1:10 to about 1:2.

After addition of the transition metal salt to the aqueous solution including the dispersed SWCNTs or graphene, the resulting mixture can be heated, e.g., refluxed, for example for about 0.5 hours to about 24 hours. In some implementations, the mixture of M-SWCNTs or M-graphene and transition metal salt in the aqueous solution can be heated for about 0.1 hours to about 20 hours, or for about 0.1 hours to about 18 hours, or for about 0.5 hours to about 15 hours, or for about 0.5 hours to about 12 hours, for about 0.5 hours to about 8 hours, or for about 2 hours to about 8 hours, or for about 4 hours to about 8 hours, or for about 5 hours to about 7 hours. The heating can for instance be performed at a temperature of about 70° C. However, a temperature below or above 70° C. could be used to heat the mixture. In some implementations, the mixture of M-SWCNTs or M-graphene and transition metal salt in the aqueous solution is heated under reflux. Although the heating can preferably be performed at normal (ambient) pressure, it could also be performed under reduced pressure. Hence, the temperature can be adapted depending on the pressure.

After refluxing, the reaction mixture can be filtered or centrifuged for allowing the transition metal coated SWCNTs or graphene to form a solid such as a pellet at the bottom of the reaction vessel. If the reaction mixture is centrifuged, the supernatant can be removed from the vessel and the M-SWCNTs or M-graphene, e.g., in the form of a pellet, can be washed with water to remove any unreacted metal salt. When the reaction mixture is filtered, e.g., using a polytetrafluoroethylene membrane (PTFE membrane), the solid remaining on the membrane, comprising the M-SWCNTs or M-graphene is washed with water. In some implementations, the solid can be washed several times to properly remove the unreacted salt. In some implementations, the solid can be re-dispersed for example by sonication, for each washing step, to improve removal of the unreacted salt. Preferably, distilled water is used to wash the solid.

In a last step, the solid can be dried. The drying can be performed at a temperature varying from about 25° C. to about 250° C. or by freeze drying at even lower temperature.

The method allows obtaining SWCNTs or graphene with an extensive coverage of metal nanoparticle and provides a uniform distribution of the nanoparticles on the SWCNTs or graphene. The nanoparticle size distribution can also be relatively homogenous. In some implementations, the nanoparticle size distribution can range from 2 nm to 5 nm and the particle distribution along the SWCNTs can represent about 50 nanoparticles for each 100 nm of SWCNT or can represent about 15 nanoparticles for each 100 nm² of graphene. Depending on the conditions and weight ratio, the size and range distributions can be further narrowed down and spaced. The resulting metal transition coated SWCNTs or graphene are suitable for being used as part of the pH responsive optical nanoprobe described herein.

pH Measurement Method

In another aspect, a pH responsive optical nanoprobe as described herein may be used for measuring the pH of a solution.

The method first includes contacting the solution with a pH responsive optical nanoprobe according to one of the embodiments described herein or similar. By way of examples, the nanoprobe may be immersed in the solution to be measured or placed in a porous glass, which is immersed in the solution to be measured.

The method next includes a step of illuminating the pH responsive optical nanoprobe with an excitation light beam having a wavelength at the optical resonance of the nanoprobe. The excitation light beam may be generated by a laser, a diode or other suitable light source. A variety of optical configurations or manners of guiding the excitation light beam toward the nanoprobe may be used inasmuch as photons from the excitation light beam can be inelastically scattered or absorbed by the M-SWCNTs or M-graphene, leading to the generation of an optical signal and the Raman scattering spectrum of the nanoprobes.

The method next includes measuring a spectral distribution of the Raman signal. Spectral analyzers such as spectrometers or the like may be used, as well as others known devices or configurations allowing the association of light intensity with wavelength.

The method can further include determining the pH of the solution from the measured spectral distribution and intensity. A processor configured to analyse the detected signal and in view of calibration data may be provided for this purpose.

In some implementations, the nanoprobe can comprise M-SWCNTs and the pH of the solution can be determined from the Raman shift of the G− mode peak associated with a LO phonon branch of the metallic SWCNTs, using the relation pH=[y(Raman-shift)−a]/b, where a and b are calibration-based fitting parameters.

In other implementations, the nanoprobe can comprise M-SWCNTs and the pH of the solution can be determined from the Raman shift of the G_{f} mode peak associated with an anomaly of the band structure of the metallic SWCNTs, using the relation pH=[y(Raman-shift)−a]/b, where a and b are calibration-based fitting parameters.

In some implementations, the nanoprobe can comprise M-SWCNTs and the pH of the solution can be determined from the intensity of the Raman G-band, using the relation pH=[y(Raman-intensity)−a]/b, where a and b are calibration-based fitting parameters.

Items

In some embodiments, the present disclosure relates to one or more of the following items:
1. A pH responsive optical nanoprobe, comprising metallic Single Wall Carbon Nanotubes (SWCNTs) or graphene coated with a transition metal M, thereby defining M-SWCNTs or M-graphene, wherein the M-SWCNTs or the M-graphene have an absorption spectrum comprising an optical resonance, and have a Raman scattering spectrum responsive to optical excitation at said optical resonance comprising at least one pH-dependent peak having at least one of a Raman shift value and an intensity that is function of a solution pH, when the nanoprobe is in contact with a solution at said solution pH.
2. The pH responsive optical nanoprobe according to item 1, wherein the Raman shift and/or the intensity of the at least one pH-dependent peak varies substantially linearly with said solution pH.
3. The pH responsive optical nanoprobe according to item 1, wherein the Raman scattering spectrum responsive to optical excitation at said resonance extends with a G band region.
4. The pH responsive optical nanoprobe according to item 3, wherein the G band region comprises Raman shift values between about 1450 cm⁻¹ and about 1650 cm⁻¹.
5. The pH-responsive optical probe according to item 4, wherein the nanoprobe comprises metallic SWCNTs and the at least one pH-dependent peak comprises a G₋ mode peak associated with a LO phonon branch of the metallic SWCNTs.
6. The pH-responsive optical probe according to item 3, wherein the nanoprobe comprises metallic SWCNTs and the at least one pH-dependent peak comprises a G_{f} mode peak associated with an anomaly of the band structure of the metallic SWCNTs.
7. The pH responsive optical nanoprobe according to item 3, wherein the nanoprobe comprises metallic SWCNTs and the Raman scattering spectrum responsive to optical excitation at said optical resonance of the metallic SWCNTs further comprises at least one pH-independent peak being a G₊ mode peak, at a Raman shift substantially insensitive to the solution pH.
8. The pH responsive optical nanoprobe according to item 1, wherein the SWCNTs have a diameter distribution of from about 0.4 nm to about 3 nm.
9. The pH responsive optical nanoprobe according to item 1, wherein the nanoprobe comprises graphene layers and/or graphene flakes.
10. The pH responsive optical nanoprobe according to item 1, wherein the metallic SWCNTs or the graphene are coated with transition metal-based nanoparticles having a particle size distribution of from about 0.9 nm to about 500 nm.
11. The pH responsive optical nanoprobe according to item 10, wherein the transition metal-based nanoparticles have a particle size distribution of from about 0.9 to about 20 nm.
12. The pH responsive optical nanoprobe according to item 1, wherein the metallic SWCNTs or the graphene are coated with a thin film comprising the transition metal and the film has a thickness of from about 0.7 to about 300 nm.
13. The pH responsive optical nanoprobe according to item 1, wherein the metallic SWCNTs or the graphene are coated with Pt, W, Pd, Ir or Ru or any alloy thereof and/or an oxide thereof.
14. The pH responsive optical nanoprobe according to item 1, wherein the transition metal comprises Pt.
15. The pH responsive optical nanoprobe according to item 1, wherein the M-SWCNTs or M-graphene are in a powder form and the powder is dispersed or encapsulated in a porous transparent material.
16. The pH responsive optical nanoprobe according to 1, wherein the solution is an aqueous solution.
17. A method for preparing graphene or SWCNTs coated with transition metal-based nanoparticles, comprising:
   preparing a dispersion comprising individualized graphene or SWCNTs comprising metallic SWCNTs;
   adding a salt of the transition metal to the dispersion to form a mixture;
   heating the mixture;
   filtering or centrifuging the mixture to recover the coated graphene or SWCNTs
   washing the coated graphene or SWCNTs with water to remove any unreacted metal salt;
   drying the coated graphene or SWCNTs.
18. The method according to item 17, wherein preparing the dispersion comprising individualized graphene or SWCNTs comprises sonicating an aqueous solution of the graphene or SWCNTs in the presence of a surfactant comprising sodium dodecyl sulfate (SDS), sodium cholate or a mixture thereof.
19. The method according to item 17, wherein the salt is a Pt salt comprising H₂PtCl₆, PtCl₂, PtBr₂, PtCl₃, PtBr₃, PtI₂, PtSO₄, PtCl₂(NH₄)₂, [Pt(NH₃)₂]Cl₄ or any mixture thereof.
20. A method for measuring the pH of a solution, comprising:
   contacting the solution with a pH responsive optical nanoprobe according to item 1;
   illuminating the pH responsive optical nanoprobe with an excitation light beam having a wavelength at said optical resonance, thereby generating a Raman signal from said pH responsive nanoprobe according to said Raman scattering spectrum;
   measuring a spectral distribution and intensity of the Raman signal;
   determining the pH of the solution from said spectral distribution and intensity.
21. The method of item 20, in combination with the probe of item 5, wherein the pH of the solution is determined from the Raman shift of the G₋ mode peak using the relation pH=[y(Raman-shift)−a]/b, where a and b are calibration-based fitting parameters.
22. The method of item 20, in combination with the probe of item 6, wherein the pH of the solution is determined from the Raman shift of the G_{f} mode peak using the relation pH=[y(Raman-shift)−a]/b, where a and b are calibration-based fitting parameters.
23. A pH responsive optical nanoprobe, comprising metallic Single Wall Carbon Nanotubes (SWCNTs) coated with a transition metal M, thereby defining M-SWCNTs, the M-SWCNTs having an absorption spectrum comprising an optical resonance, and having a Raman scattering spectrum responsive to optical excitation at said optical resonance comprising at least one pH-dependent peak having at least one of a Raman shift value and an intensity that is function of a solution pH, when the nanoprobe is in contact with a solution at said solution pH.
24. The pH responsive optical nanoprobe according to item 23, wherein the Raman shift and/or the intensity of the at least one pH-dependent peak varies substantially linearly with said solution pH.
25. The pH responsive optical nanoprobe according to item 23 or 24, wherein the Raman scattering spectrum responsive to optical excitation at said optical resonance extends with a G band region.
26. The pH responsive optical nanoprobe according to item 25, wherein the G band region comprises Raman shift values between about 1450 cm⁻¹ and about 1650 cm⁻¹.
27. The pH-responsive optical probe according to item 25 or 26, wherein the at least one pH-dependent peak comprises a G− mode peak associated with a LO phonon branch of the metallic SWCNTs.
28. The pH-responsive optical probe according to item 25, 26 or 27, wherein the at least one pH-dependent peak comprises a G_{f} mode peak associated with an anomaly of the band structure of the metallic SWCNTs.
29. The pH responsive optical nanoprobe according to any one of items 25 to 28, wherein the Raman scattering spectrum responsive to optical excitation at said optical resonance of the metallic SWCNTs further comprises at least one pH-independent peak at a Raman shift substantially insensitive to the solution pH.
30. The pH-responsive optical probe according to item 29, wherein the at least one pH-independent peak comprises a G₊ mode peak associated with a TO phonon branch of the metallic SWCNTs.
31. The pH responsive optical nanoprobe according to any one of items 23 to 30, wherein the SWCNTs have a diameter distribution of from about 0.4 nm to about 3 nm.
32. The pH responsive optical nanoprobe according to any one of items 23 to 31, wherein the SWCNTs have a diameter distribution of from about 1.0 nm to about 1.5 nm.
33. The pH responsive optical nanoprobe according to any one of items 23 to 32, wherein the metallic SWCNTs are coated with transition metal-based nanoparticles.
34. The pH responsive optical nanoprobe according to item 33, wherein the transition metal-based nanoparticles have a particle size distribution of from about 0.9 nm to about 500 nm.
35. The pH responsive optical nanoprobe according to item 33, wherein the transition metal-based nanoparticles have a particle size distribution of from about 0.9 to about 20 nm.
36. The pH responsive optical nanoprobe according to any one of items 23 to 32, wherein the metallic SWCNTs are coated with a thin film comprising the transition metal.
37. The pH responsive optical nanoprobe according to item 36, wherein the thin film of the transition metal has a thickness of from about 0.7 to about 300 nm.
38. The pH responsive optical nanoprobe according to any one of items 23 to 37, wherein the metallic SWCNTs or the graphene are coated with Pt, W, Pd, Ir or Ru or any alloy thereof and/or an oxide thereof.
39. The pH responsive optical nanoprobe according to any one of items 23 to 37, wherein the transition metal comprises Pt.
40. The pH responsive optical nanoprobe according to any one of items 23 to 39, wherein the M-SWCNTs comprise metallic SWCNTs and semiconducting SWCNTs.
41. The pH responsive optical nanoprobe according to any one of items 23 to 39, wherein the M-SWCNTs comprise substantially solely metallic SWCNTs.
42. The pH responsive optical nanoprobe according to any one of items 23 to 41, wherein the coated M-SWCNTs are in a powder form and the powder is dispersed or encapsulated in a porous transparent material.
43. The pH responsive optical nanoprobe according to item 42, wherein the porous transparent material comprises porous glass or porous glass-ceramic.
44. The pH responsive optical nanoprobe according to any one of items 23 to 43, wherein the solution is an aqueous solution.
45.A method for preparing SWCNTs coated with transition metal-based nanoparticles, comprising:
   sonicating an aqueous solution of surfactant wrapped SWCNTs comprising metallic SWCNTs;
   adding a salt of the transition metal to the sonicated solution to form a mixture;
   heating the mixture;
   filtering or centrifuging the mixture to obtain the coated SWCNTs;
   washing the coated SWCNTs with water to remove any unreacted metal salt;
   drying the coated SWCNTs.
46. The method according to item 45, wherein the surfactant comprises sodium dodecyl sulfate (SDS), sodium cholate or a mixture thereof.
47. The method according to item 45 or 46, wherein the wrapped SWCNTs are at a concentration of from about 0.1 μg/ml to about 200 μg/ml of the aqueous solution.
48. The method according to any one of items 45 to 47, wherein the wrapped SWCNTs are sonicated for about 1 min to about 200 min.
49. The method according to any one of items 45 to 48, wherein the salt is a Pt salt comprising H₂PtCl₆, PtCl₂, PtBr₂, PtCl₃, PtBr₃, PtI₂, PtSO₄, PtCl₂(NH₄)₂, [Pt(NH₃)₂]Cl₄ or any mixture thereof.
50. The method according to any one of items 45 to 49, wherein the salt is a Pd salt comprising PdCl₂, PdBr₂, PdI₂, [Pd(NH₃)₄]Br₂, [Pd(NH₃)₄]Cl₂, Pd(SO₄) or any mixture thereof.
51. The method according to any one of items 45 to 50, wherein the salt is a Ru salt comprising RuCl₂, RuI₂, [Ru(NH₃)₆]Cl₂ or any mixture thereof.
52. The method according to any one of items 45 to 51, wherein the salt is a W salt comprising WCl₄, WCl₆, an Ir salt comprising IrCl₂, IrCl₄, or any mixture thereof.
53. The method according to any one of items 45 to 52, wherein the transition metal salt is added to the sonicated solution in a weight ratio nanotube:metal of from about 1:500 to about 10:1.
54. The method according to any one of items 45 to 53, wherein the mixture is refluxed for about 0.5 hours to about 24 hours.
55. The method according to any one of items 45 to 54, wherein the pellet is dried at a temperature of from about 25° C. to about 250° C.
56. The method according to any one of items 45 to 55, wherein the SWCNTs have a diameter distribution of from about 0.4 nm to about 3 nm.
57. The method according to any one of items 45 to 55, wherein the SWCNTs have a diameter distribution of from about 1.0 nm to about 1.5 nm.
58. The method according to any one of items 45 to 57, wherein the transition metal-based nanoparticles have a particle size distribution of from about 0.9 to about 500 nm.
59. The method according to any one of items 45 to 57, wherein the transition metal-based nanoparticles have a particle size distribution of from about 0.9 to about 20 nm.
60. The pH responsive optical nanoprobe according to any one of items 23 to 44, wherein the coated SWCNTs are prepared according to the method of any one of items 45 to 59.
61.A method for measuring the pH of a solution, comprising:
   contacting the solution with a pH responsive optical nanoprobe according to any one of items 23 to 44 and 60;
   illuminating the pH responsive optical nanoprobe with an excitation light beam having a wavelength at said optical resonance, thereby generating a Raman signal from said pH responsive nanoprobe according to said Raman scattering spectrum;
   measuring a spectral distribution and intensity of the Raman signal;
   determining the pH of the solution from said spectral distribution and intensity.
62. The method of item 61, in combination with the probe of item 27, wherein the pH of the solution is determined from the Raman shift of the G₋ mode peak using the relation pH=[y(Raman-shift)−a]/b, where a and b are calibration-based fitting parameters.
63. The method of item 61, in combination with the probe of item 28, wherein the pH of the solution is determined from the Raman shift of the G_{f} mode peak using the relation pH=[y(Raman-shift)−a]/b, where a and b are calibration-based fitting parameters.
64. The method of item 61, in combination with the probe of item 28, wherein the pH of the solution is determined from the Raman intensity of the G band using the relation pH=[y(Raman-intensity)−a]/b, where a and b are calibration-based fitting parameters.

### EXAMPLES

The sections below provide examples of results related to embodiments of the pH responsive nanoprobes such as described above, and should not be taken as limitative to the scope of protection.

### Example 1

We herein present an optical pH sensor based on the Raman response of metallic Single-Walled Carbon Nanotubes (SWCNTs) functionalized with platinum, palladium or ruthenium nanoparticles (Pt_{N}-SWNTs, Pd_{N}-SWNTs, Ru_{N}-SWNTs). SWCNTs have been chosen because of their huge surface-to-volume ratio and their strong Raman activity¹⁸, which make them well adapted to the development of sensors for biology and medicine¹⁸⁻²². The Raman G-band of SWCNTs is of particular interest for sensor applications as it provides significant softening (red-shift) or stiffening (blue shift) of the G-band with nanotube doping²³⁻²⁷. Here, we report that the Raman signal of Pt_{N}-SWNTs can be used for making referenced measurement of the local pH over a wide range (pH=0-12) with a best accuracy of ±500 mpH unit. The signal of Pt_{N}-SWNTs supported on an oxide surface in solution consists of a reversible and reproducible transformation of the Raman G-band upon changes in the solution pH. Raman spectral shifts and intensities are linear with pH, which is ascribed to charge transfer doping of the SWCNTs via the Pt/PtO redox pair according to the equilibrium reaction: PtO+2H⁺+2e⁻(SWCNT)⇄Pt+H₂O. This study demonstrates that the Raman signal can be used to reference the electrochemical potential of the solution. This optical nanotube-based pH sensor consisting of a referenced nanotube redox reporter is discussed as the nanoscale optical analogue of a conventional pH sensor.

Materials

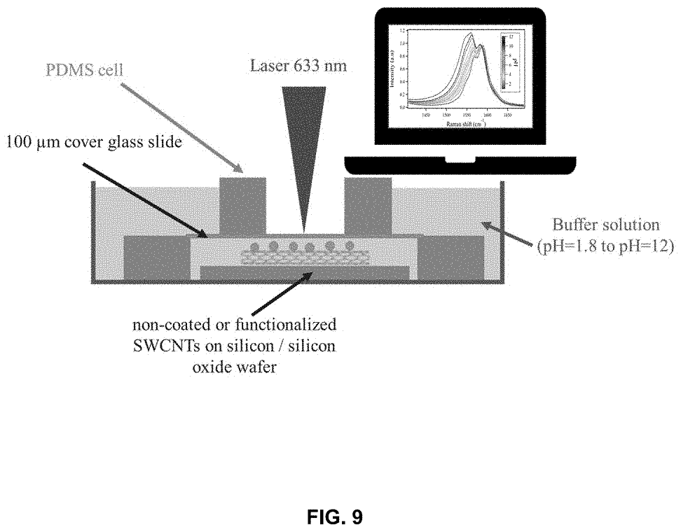

SWCNTs with a diameter distribution of 1.1-1.5 nm were produced by laser ablation²⁸. Chloroplatinic acid hydrate (H₂PtCl₆.xH₂O, ≥99.9%) and sodium borohydride (NaBH₄) were from Sigma-Aldrich. Nitric acid (HNO₃), sulfuric acid (H₂SO₄), acetic acid, phosphoric acid, boric acid, sodium hydroxide (NaOH), hydrochloric acid (HCl), potassium chloride (KCl), acetone, and isopropyl alcohol were used as received from Fisher Scientific. Raman spectra were acquired using a Raman spectrometer (Renishaw, InVia) with two excitation wavelengths (λₑₓ=514 nm and 633 nm) and a maximum power of 150 μW μm⁻². Although the main region of interest is around the G-band (1450-1650 cm⁻¹), spectra were recorded from 100-3000 cm⁻¹. Acquisition times of 10-30 s were used to achieve a good signal to noise ratio. Raman measurements in a pH-controlled liquid were performed by using the liquid cell shown in FIG. 9 (Supporting Information provided in Annex A). The size of the platinum nanoparticles was estimated using a Transmission Electron Microscope (TEM) operated at 200 kV in the bright field mode (JEOL 2100-F FEG-TEM). TEM samples were prepared by ultrasonication of aqueous solutions of the platinum decorated SWCNTs for 30 min. A drop of the suspension was deposited on a standard TEM grid covered with a lacey carbon film and dried in air. The Education Series EL20 Benchtop pH Meter, METTLER TOLEDO pH metre, with three standard buffer solutions (pH=4.01, pH=7.00, and pH=10.00) were used for calibration. Buffer solutions of different pH were prepared using acetic acid, phosphoric acid, boric acid, and sodium hydroxide. Potassium chloride was used to fix the ionic strength of the buffer solutions to 1 M.

Preparation of Solid-Supported SWCNTs

The SWCNTs were purified by refluxing in concentrated nitric acid for 24 h, and then collected on a PTFE filter (0.2 μm pore size). Subsequently, the residue of SWCNTs was washed with deionized water, followed with solutions of diluted NaOH and HCl to neutralize the pH. Thin films of SWCNTs were prepared by vacuum filtration of an aqueous dispersion of SWCNTs (7.5×10⁻⁹ g/L) through a nitrocellulose membrane and then transferred to a patterned substrate consisting of an oxidized silicon wafer (Si/SiO₂, thickness=300 nm). More details about the substrate patterning and functionalization are given in the Supporting Information in Annex A. The membrane was removed by dissolving in a bath of acetone followed (without drying) by soaking in isopropanol while ensuring that the SWCNT film remained on the receiving surface.

Synthesis of Pt-SWCNTs and Pt_{N}-SWCNTs

Two methods of deposition were used to prepare Pt-coated SWCNTs for the Raman experiments. The first method employed an electron beam (e-beam) evaporator to deposit about 10 nm of platinum on a mat of entangled SWCNTs supported on the oxidized silicon wafer. The resulting sample is hereafter referred to as Pt-SWCNT. The second method involves a one pot preparation from platinum nanoparticles grown in solution using H₂PtCl₆.xH₂O and sodium borohydride as reducing agent, giving a sample labeled as Pt_{N}-SWCNTs. First, SWCNTs were ultrasonically dispersed in deionized water mixed with 2-propanol. The metal precursor (H₂PtCl₆.xH₂O) was then added to the solution to reach a total metal content of 40 wt. % vs. SWCNTs. The mixture was heated up to 80° C. in the presence of a NaBH₄ solution under vigorous agitation. Finally, the mixture was filtered, washed and dried under vacuum at 120° C. for 4 hours.

General Synthesis of M_{N}-SWCNTs by Wet Chemistry

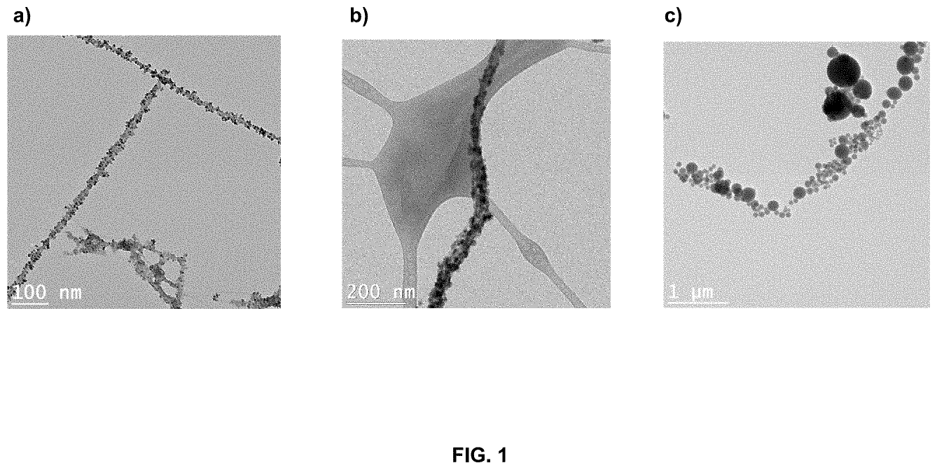

An alternative method for the synthesis of metal nanoparticles deposited on single walled carbon nanotubes (SWCNT) was developed using a novel wet chemistry approach described below: 2 ml of sodium dodecyl sulfate (SDS) wrapped carbon nanotubes (10 μg/ml) was sonicated for 15 minutes. The respective metallic salt was added in a proportion of 1:50 in weight (nanotubes:metal precursor) to the sonicated solution of nanotubes. The resulting mixture was refluxed for six hours at 70° C. The solution was centrifuged at 12000 rpm for 10 minutes to obtain the pellet at bottom followed by thorough washing with distilled water several times (10 times) to remove any unreacted salt from the solution. Finally, the pellet was dried at 50° C. at ambient pressure and used further for pH sensing experiments. TEM images of the product of this synthesis for Pt_{N}-SWCNTs, Pd_{N}-SWCNTs and Ru_{N}-SWCNTs are shown in the FIG. 1. As can be seen, the coverage of nanoparticle obtained is extensive and the method provides a uniform distribution along the SWCNTs. The size distributions are also very narrow, especially for the Pt and Pd systems.

Results and Discussion

The Raman Response of Pt-SWCNTs with pH

The Raman response of Pt-SWCNTs prepared by e-beam deposition was first benchmarked against a thin film of SWCNTs that are similarly treated but without Pt. FIG. 2 presents the G-band region (1450-1650 cm⁻¹) of the Raman spectra of both samples in buffer solutions of pH ranging from 1.80 to 11.80. For these sets of experiments, an excitation wavelength of λₑₓ=632 nm was selected to specifically target the optical resonance of the metallic nanotubes in our sample. While semiconducting SWCNTs are present, these species are not in resonance at 632 nm due to the diameter distribution, and hence their Raman signal does not appear in the spectra²⁸. The Raman spectra of both samples undergo changes as a function of the solution pH, but the overall spectral response of the Pt-SWCNT sample (FIG. 2a) is significantly more pronounced than that of the SWCNTs. As explained below, this result is central to our study.

More details about the spectral transformations with pH are garnered from each of the three components of the G-band region. The first peak at the highest Raman shift, labeled G₊ mode, is clearly the least affected by pH. This mode is associated with the TO phonon branch with movements of atoms along the nanotube axis. Because its position and intensity vary little with pH, the G₊ mode can serve as a spectral reference point for normalization. By contrast, the second and third peaks located below the G₊ mode evolve with pH. These components of the Raman signal are the most interesting for sensing and discussed next using the responses shown in FIG. 2a. The peak labeled G₋ mode, which is right below the mode, is ascribed to LO phonons with a component along the circumferential direction of the nanotube. This mode has been reported to undergo a blue shift upon doping, a behavior ascribed to strong electron-phonon coupling in SWCNTs, which affects the lattice parameters (i.e., C—C bond length) and renormalize the phonon energy^{29, 30} Because of its peculiar lineshape (broad and asymmetrical), the low energy peak at around 1548 cm⁻¹ is called the Fano mode (labeled here as G_{f}). Due to a Kohn anomaly in the nanotube band structure, the position and shape of the G_{f} mode depend strongly on charge density; mode broadening and softening are maximum when the doping state of the SWCNT is near charge neutrality^{26,30-35} As discussed below, these important characteristics of the G_{f} mode can be used to reference the potential of the solution.

In FIG. 2a, both the shift of the G₋ mode and the asymmetric broadening of the G_{f} mode of Pt-SWCNTs are clear signatures of a doping process in which the pH of the solution consistently shifts the Fermi level of the metallic SWCNTs. On the basis of the trends observed, i.e., red shifting of the G₋ mode across the entire pH range of 1.80 to 11.80 investigated and maximal broadening of the G_{f} mode at pH 12, we can deduce that the SWCNTs are p-doped at pH and quasi undoped at pH 12. In comparison with previous work, the Raman shifts observed here are higher than those reported in doping studies of SWCNT devices using gate voltages²⁶ and the behavior in FIG. 2a is comparable to that measured for Raman spectroelectrochemistry of metallic SWCNTs³⁶.

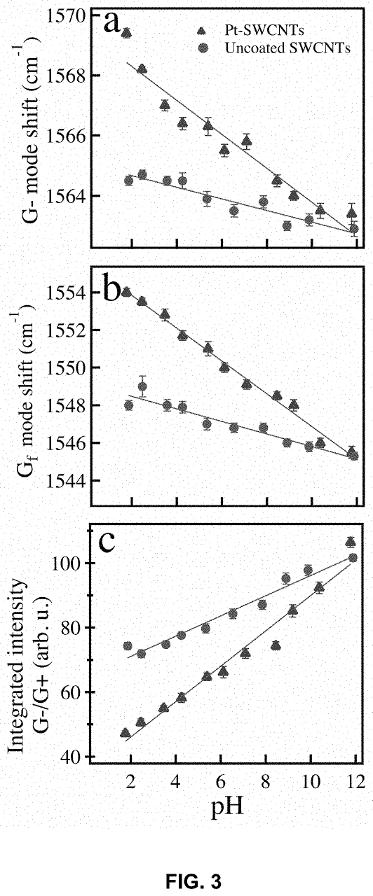

A qualitative comparison of the pH response of metallic SWCNTs prepared with and without Pt shows that the local environment surrounding the SWCNTs is a key parameter controlling the doping process. That is, the gradual and uniform transformation of the G-bands of Pt-SWCNTs (FIG. 2a) over the full pH range contrasts with the almost unperturbed Raman spectrum of the uncoated SWCNTs in the pH range of 1-8 (FIG. 2b). To quantify the different responses of each sample, FIG. 3 reports the results of a deconvolution of the G-bands at each pH step (peak fitting details are provided in the Supporting Information in Annex A). There are several significant observations. First, the Raman shifts of the G₋ and G_{f} modes and the normalized integrated intensity of the G₋ mode relative to the G₊ mode (hereafter labeled I(G₋/G₊)) show nearly linear dependencies with pH. Compared to the SWCNTs, the slopes of the G₋-pH and G_{f}-pH plots are steeper for the Pt-coated SWCNTs (i.e., G_{f} mode gives −0.89±0.02 cm⁻¹/pH unit vs. −0.33±0.03 cm⁻¹/pH unit), hence three-fold larger for every incremental increase of the pH unit. For both samples, the G₋ and G_{f} modes red shift with pH and the I(G₋/G₊) also increases with pH. Surprisingly, both samples give similar fitting parameters at pH≈12, meaning that SWCNTs are roughly at the same doping state, i.e., near the charge neutrality. Last, pH-induced doping takes place in both cases, but the doping is much stronger for metallic SWCNTs in contact with Pt.

The different pH dependencies of the G-band between the two samples are rationalized by the reduction-oxidation (redox) reactions occurring in the environment around the SWCNT film. According to the Marcus-Gerischer theory^{37,38}, charge transfer on solid electrodes can be estimated using the overlap integral between the occupied/unoccupied states at the valence and conduction band edges of the electrodes and the unoccupied/occupied states of the redox system at the origin of hole (p-type) or electron (n-type) doping. In electrochemistry language, charge transfer is mainly driven by the difference between the electrochemical potentials, E_{redox}, of the redox couple and internal potential, E_{f}, of the SWCNTs. In solution, the reaction proceeds until an equilibrium is reached between the two systems (i.e., E_{redox}=E_{f}), effectively resulting in the electrochemical doping of the SWCNTs. As previously proposed by our team to explain the unintentional doping of SWCNT transistor devices, air doping can be ascribed to the O₂/H₂O redox pair according to the well-known reaction: O_{2(aq)}+4H⁺_{(aq)}+4e⁻(SWCNT) [symbol] 2H₂O_{(I)}).^{39,40} For this redox couple, a fundamental expression of the potential under equilibrium conditions is given by the Nernst equation:

$${E}_{{O}_{2} / {H}_{2} O} = 1.229 + \frac{0.0592}{4} {log}_{10} ( {p O}_{2} ) - 0 .059 \cdot pH \\ or {E}_{{O}_{2} / {H}_{2} O} = 1.2 \; 26 - 0.059 \cdot pH \qquad ( 1 )$$

where pO₂=0.65 bar is the oxygen pressure, which is equivalent to an oxygen concentration of 8.26 mg/L, under the experimental conditions used here. E_{O}_{₂}_{/H}_{₂}_{O} is expressed in Volt in equation 1. In the context of solids, the potential is more conveniently defined in terms of energy level (in eV) with respect to the vacuum level using the expression:

E_{abs,O}_{₂}_{/H}_{₂}_{O}=−4.44−1.229+E_{O}_{₂}_{/H}_{₂}_{O}

or E_{abs,O}_{₂}_{/H}_{₂}_{O}=−5.669+0.059·pH (2)

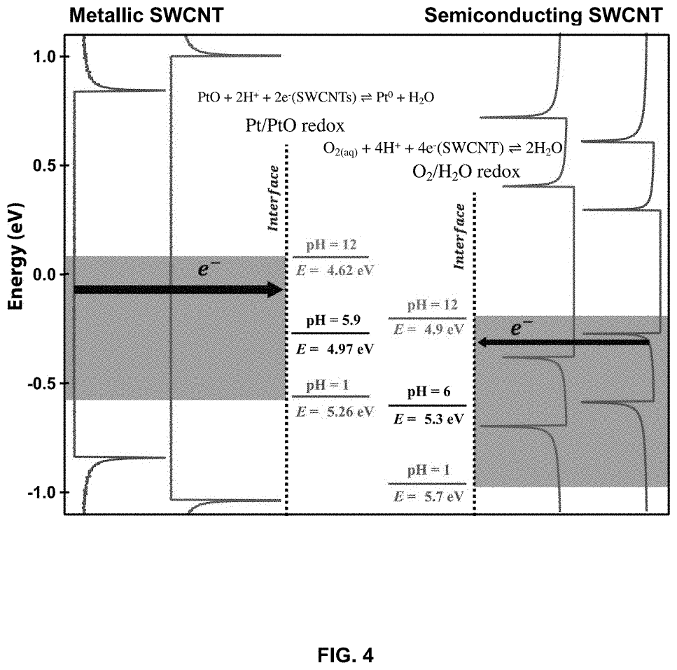

Hence, depending on the pH of the solution, the energy level or Fermi energy lies between −5.61 eV (pH=1) and −4.95 eV (pH=12) (See FIG. 4).

Because the valence band of small diameter semiconducting SWCNTs is roughly located between −5.3 eV and −5.7 eV, which is close to the redox potential of O₂/H₂O in acidic solutions (FIG. 4), electrons can transfer from the SWCNTs to the solution, yielding p-doping in air⁴⁰. The presence of finite energy states of metallic SWCNTs provides significant charging for ensuring energy level alignments with the absolute O₂/H₂O redox system at every pH value between 1 and 12. However, our experiments with uncoated SWCNTs (FIG. 2b) show only small shifts of the G₋ and G_{f} modes, indicating little or no charge transfer with pH. This sluggish pH dependency is ascribed to exceedingly slow kinetics at the surface of the SWCNTs for oxygen oxidation/reduction, i.e., non-Nernstian behavior. Namely, charge transfer to aqueous oxygen produces unstable intermediates on the surface of the SWCNTs, which cannot be easily anchored to the surface of the SWCNT, and hence, they can move back to the solution after transfer, yielding only partial reaction (4 electrons in total are required for the equilibrium). In other words, the SWCNTs have self-passivated surfaces and the oxidized form is poorly stable, which is bad chemically for ensuring the equilibrium of the O₂/H₂O redox system. As discussed below, a Pt coating provides different kinetics in this respect because the Pt/PtO redox pair can produce stable reduction/oxidation states while direct contact enables free charge transfer to the metallic SWCNTs. In effect, the platinum nanoparticles provide sites for the strong chemisorption of oxygen, thereby making the splitting of aqueous O₂ more efficient than on uncoated SWCNTs.

Many studies have demonstrated that the platinum surface in air contains a mixture of Pt and PtO^{41, 42}. The Pt/PtO redox couple could therefore compete with the O₂/H₂O reduction reaction discussed above according to:

PtO+2H⁺+2e⁻(SWCNTs) [symbol] Pt⁰+H₂O.

The redox potential of the Pt-SWCNT system is therefore given by: E_{Pt/PtO}=0.88−0.059·pH, where E_{Pt/PtO} is in Volt¹⁶. The energy level (in eV) with respect to the vacuum level is⁴³:

E_{Pt/PtO}=−4.44−0.88+0.059·pH (3)

In FIG. 4, the energies of both redox systems, O₂/H₂O and Pt/PtO, at different pH values are presented with respect to the vacuum level, and serve as a theoretical standpoint for the discussion of the pH dependencies. Using a work function of 4.7 eV for the SWCNTs⁴⁴, the model can be used to predict the equilibrium position of the potential depending on the pH of the solution. In an acidic solution of pH 1, the diagram predicts, for example, that the energy level of the Pt/PtO redox pair lies between the first and second valence band edges of semiconducting SWCNTs, while it is deeper below the second band edge for the O₂/H₂O redox pair. In a basic solution of pH 12, the energy level of Pt/PtO redox pair is near midgap, whereas it is next to the valence band for the O₂/H₂O redox pair.

This model provides an interesting comparison with the pH-induced spectral changes presented in FIGS. 2 and 3. The model predicts that the Pt-SWCNT system should drive at pH=12 the nanotube Fermi level towards the midgap, which is consistent with the broad and red shifted spectrum in FIG. 2a. Unexpectedly, the model predicts a potential difference of about 0.3 eV with uncoated SWCNTs, but the results (FIG. 2b) show instead an undoped situation at pH=12 for the latter, i.e., the equilibrium should favor p-doping whereas the Raman spectrum indicates midgap alignment. We hypothesize that the inconsistency between the model and the experimental findings on uncoated SWCNTs is probably due to slow kinetics, giving out-of-equilibrium conditions, which implies that the SWCNT is a poor redox system. That is, uncoated SWCNTs are self-passivated, hence, their surfaces cannot stabilize intermediate species of the O₂/H₂O equilibrium reaction, whose presence is required to stabilize the positive charges (p-dopant) on the nanotubes.

Effect of the Ionic Strength of the Buffer Solution

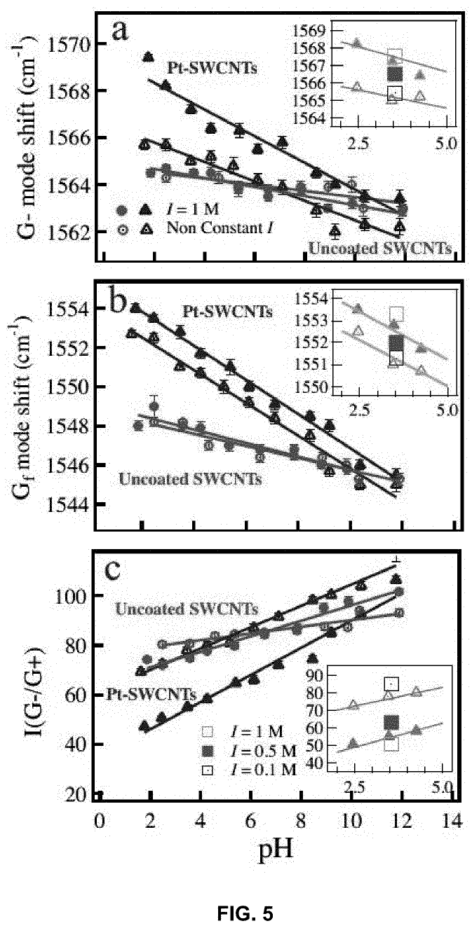

In the experiments presented in FIG. 2, the ionic strength (I) of the buffer solutions was kept constant at 1 M⁴⁵. To address the aforementioned discrepancy between the observed Raman shifts (FIG. 3) and the model presented in FIG. 4, we explored the effect of the ionic strength of the buffer solution on the resulting doping states of uncoated SWCNTs and Pt-SWCNT samples. Buffer solutions of different ionic strengths were prepared with the same ionic species for the different pH's and the results are presented in FIG. 5. The ionic strength does not significantly impact the pH response of the Pt-SWCNTs, as evidenced by the parallel slopes of the G₋ and G_{f} modes. However, when measured in buffer solutions where I is not constant, the Raman modes show shifts that are generally downshifted relative to that of the buffer solutions of constant I. As discussed above, the Raman shift of the G₋ mode indicates that charge transfer doping drives the Pt-SWCNTs response. Hence, this downshifting for a given pH is a clear indication of a significant doping change associated to charge screening from the ions in solution⁴⁶. The effect is more clearly illustrated using three solutions of fixed pH (3.54) but different ionic strength (I=1, 0.5, and 0.1 M) (see insets of FIG. 5). For a given pH, decreasing the ionic strength generally reduces the doping level, which is evidenced by a blue shift of the G₋ and G_{f} modes (insets of FIG. 5a,b) with increasing I. The effect is also noted in the inset of FIG. 5c by a general decrease of the integrated intensity with I.

Surprisingly, the effect of the ionic strength on the Raman shift of the G-band of the uncoated SWCNTs is very weak. Additionally, it is interesting to point out that a reduction of the ionic strength, i.e., lower screening, does shift the doping state towards the energy position predicted by the model. That is, the model in FIG. 4 indicates that charge neutrality should be observed at pH of >12 and ˜5.6 for the uncoated SWCNTs and Pt-SWCNTs, respectively. The results in FIG. 5 indicate, however, that this is indeed the case but for a solution with I=0.1 M. This surprising result demonstrates that the pH response is mostly driven by the Pt/PtO reaction and that the reaction at the SWCNT surface in the bare section has no of little effect on the final potential of the Pt-SWCNT system. Overall, all of the experiments on uncoated SWCNTs show a reduced pH response and no noticeable screening effects from the ions, which reinforces our conclusion that an uncoated SWCNT is a poor redox couple. Our investigation of the effects of additional parameters on pH sensing was therefore pursued with the Pt-coated SWCNT samples.

Formulation of a pH Sensitive Nanoprobe

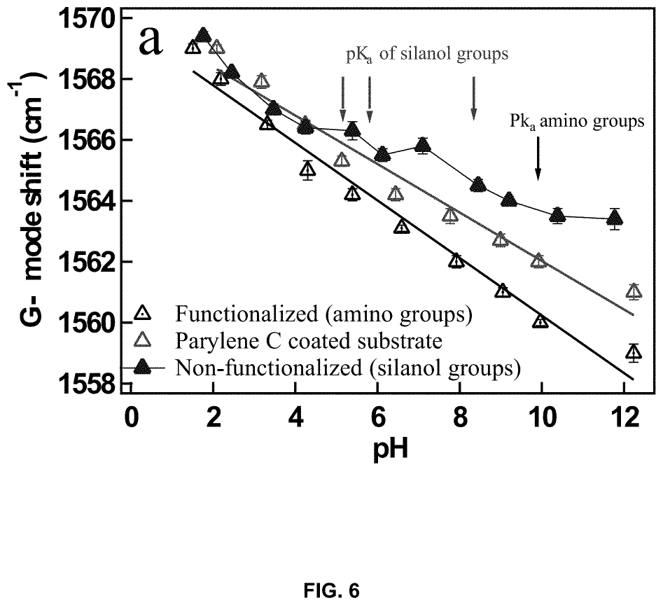

Our previous results demonstrate the high sensitivity of Pt-coated SWCNTs to the local pH. This effect must be optimized to construct a practical pH sensor. We specifically investigate the potential errors introduced by the local environment to the pH measurement. To highlight possible interferences from the substrate, two kinds of surfaces were prepared: i) parlyene-C deposited on an oxidized silicon wafer and ii) an aminoalkyl-silanized oxidized silicon wafer, for which the results are be compared with those of an oxidized silicon substrate (i.e., without surface modification). On the one hand, we note that an organo-silane surface significantly improves the adhesion of the SWCNT film, which is easily peeled off from the untreated Si/SiO₂. On the other hand, parlyene C renders the adhesion more problematic, but it should eliminate the effect of the oxide surface on pH sensing as it has no acid/base functional groups capable of local charging. The shift of the G₋ mode of the Pt-coated SWCNTs with pH on these substrates are presented in FIG. 6 (see Supporting Information in Annex A for G_{f} mode shift and I(G₋/G₊)).

The Raman shifts on all three surfaces are similar at low pH, but deviations are clearly observed at higher pH, which results in different slopes. Depending on the preparation and cleaning steps, the surface of the Si/SiO₂ wafer (without functionalization) can be chemically complex as it exhibits different densities of functional groups (silanols, protonated and deprotonated silanols), each with their own pKₐ. At a given pH, these groups influence the local surface charge next to the deposited SWCNTs. For example, the pKₐ of silanols (Si—OH) is approximately 5.6 or 8.5, depending if they are out-of-plane or in-plane, respectively, and protonated silanols (Si—OH₂⁺) have a pKₐ˜5⁴⁷. For clarity, the above pKₐ's are indicated by blue arrows in FIG. 6. The silanization reaction converts the terminal silanols into amino groups (pKₐ˜10, black arrow), which adds further complexity to the surface depending on the density of all of the functional groups. As mentioned before, we probe the charge state of the SWCNTs for pH sensing and the results show that the different surface functional groups complicate the response and influence locally the charge density on the SWCNTs. The theoretical pKₐ values indicate that the silanized and untreated Si/SiO₂ surfaces have mostly basic groups, which is consistent with the deviations of the G₋ mode shifts from those of the parlyene C at higher pH. Again, the effect of the supporting substrates demonstrates that the Pt-SWCNTs are highly sensitive to the local environment. The measurement of the pH is therefore influenced by the local potential, which induces an error compared to the electrochemical potential in the bulk of the solution.

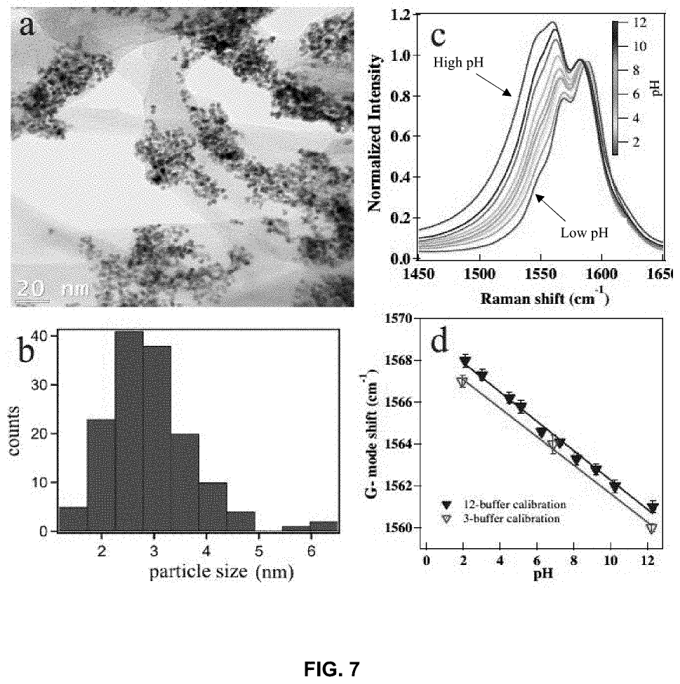

To address the potential problem of uniformity in the preparation of the Pt-SWCNTs, we developed a synthesis procedure (see above) to prepare SWCNTs uniformly coated with Pt nanoparticles (Pt_{N}-SWCNTs) and used films of these Pt_{N}-SWCNTs as a proof of concept of a pH sensor. FIG. 7a shows a TEM image of the morphology of the sample from which the size distribution of the Pt nanoparticles is obtained (FIG. 7b). The Pt_{N}-SWCNTs deposited as a thin film on an aminoalkyl-silanized silicon/silicon oxide wafer were used to test the pH response of the sensor. Compared to the Parylene C surface, which was found to induce residual stress after deposition (more information in the Supporting Information in Annex A), the silanized surface, although more complex chemically, presents better adhesion and good stability. As shown in FIG. 7c, the Pt_{N}-SWCNTs provide the expected strong Raman response to pH, namely a shift of the G₋ mode by more than 7 cm⁻¹ across the pH values between 2 and 12. The results for the G_{f} mode and the I(G₋/G₊) are shown in the Supporting Information (Annex A). To examine the accuracy of a pH measurement, two different calibration curves were constructed: a calibration based on solutions of 12 buffers of pH values between 1 and 12 (12-point curve) and another based on 3 buffers (3-point curve, pH=1.93, 6.87, and 12.22). This procedure is analogous to the calibration of a standard pH meter with, for example, three buffer solutions. As seen in FIG. 7d, the calibration curves for the G₋ modes (see Supporting Information in Annex A for G_{f} mode and I(G₋/G₊)) show similar slopes (−0.71 and −0.68 for 12- and 3-buffers, respectively). While the 12-point calibration is statistically more accurate, the 3-point calibration is much quicker to perform and shows a similarly good precision.

As a final proof of the feasibility of the Pt_{N}-SWCNT pH sensor for analytical measurements, we prepared three different Pt_{N}-SWCNT samples and exposed them to solutions of different pH. For comparison, the pH of the test solutions were measured using a conventional pH meter equipped with a combined glass electrode. Using the standard calibrations in FIG. 7d, the solution pH was determined using the Raman shifts with the relation y(Raman-shift)=b·(pH)+a, where a and b are fitting parameters (the uncertainty is obtained from the linear regression). Raman measurements were carried out on 5 different spots of the samples, each repeated 3 times. The data and fitting parameters are summarized in Table 1. The pH values determined from the 12-point calibration curve drawn are very close to the pH values measured using the commercial pH meter calibrated with three buffer solutions (pH=4.01, 7.00, and 10.00). While the precision remains high across the full range, the accuracy of the Raman-based measurements is about ±700 mpH in basic solutions and ±500 mpH in acidic solutions. This slight difference is ascribed to the response of the silanized surface. The precision appears lower for acidic solutions with non-constant ionic strength, which is expected considering the importance of the ion concentration for screening the local electrochemical potentials. Using the 12-point calibration, both the precision and accuracy is generally improved, but the procedure requires additional effort to gain better statistics.

To our knowledge, the remote platinum-coated SWCNT optical sensor presents improved flexibility and accuracy compared to other electrodeless optical sensors⁴⁸⁻⁵⁰, which have issues such as a limited pH range and lack of accuracy. One recent non-conventional pH sensor based on a graphene transistor, that includes working and reference electrodes, provides for instance a much higher accuracy of ˜0.1 mpH, but it is electrically biased relative to a reference electrode⁵¹. Compared to conventional (electrode-based) pH meters, which provide accuracies ranging from ±0.1 pH to ±0.001 pH (e.g., Mettler Toledo and Fisher Scientific instruments), the Pt_{N}-SWCNT-based Raman sensor in its current version shows a lower accuracy. It has, however, the advantages of being optically addressed, electrode-less, and of nanoscale dimensions. Hence, the Pt_{N}-SWCNT pH sensor is uniquely flexible and appears complementary and useful for remote investigations of the local pH at the nanometer scale or in living cells.

TABLE 1
pH values of unknown solutions (at constant and non-constant ionic
strengths) obtained from 3-point and 12-point calibration curves using
the Raman shift of the G− mode. For comparison, the pH from a
conventional pH meter is also given.

| pH* | pH (3 buffers)** | pH (12 buffers)*** |
|---|---|---|
| pH meter | Pt_{N}-SWCNTs | Pt_{N}-SWCNTs |
| 4.80 ± 0.01 | 3.4 ± 0.9 | 4.5 ± 0.7 |
| (I = 1M) | | |
| 11.80 ± 0.01 | 11 ± 1 | 11.5 ± 0.7 |
| (I = 1M) | | |
| 4.50 ± 0.01 | 3.3 ± 0.8 | 4.5 ± 0.5 |
| 11.00 ± 0.01 | 10 ± 1 | 10.8 ± 0.7 |

*Note:
error is the instrumental error
**Note:
error of 3 buffers is obtained using the parameters: a = 1568.4 ± 0.3; b = −0.68 ± 0.04
***Note:
error of 12 buffers is obtained using the parameters: a = 1569.3 ± 0.2; b = −0.71 ± 0.02

Synthesis and Properties of pH Sensitive Nanoprobe with Different Metals

Last, we have tested a novel approach to synthesize the nanoparticle-SWCNTs sensor films using different transition metals, Pt_{N}-SWCNTs, Pd_{N}-SWCNTs and Ru_{N}-SWCNTs. The alternative synthesis is described above under General Synthesis of M_{N}-SWCNTs and the resulting structures and morphologies are shown in the TEM images of FIG. 1.

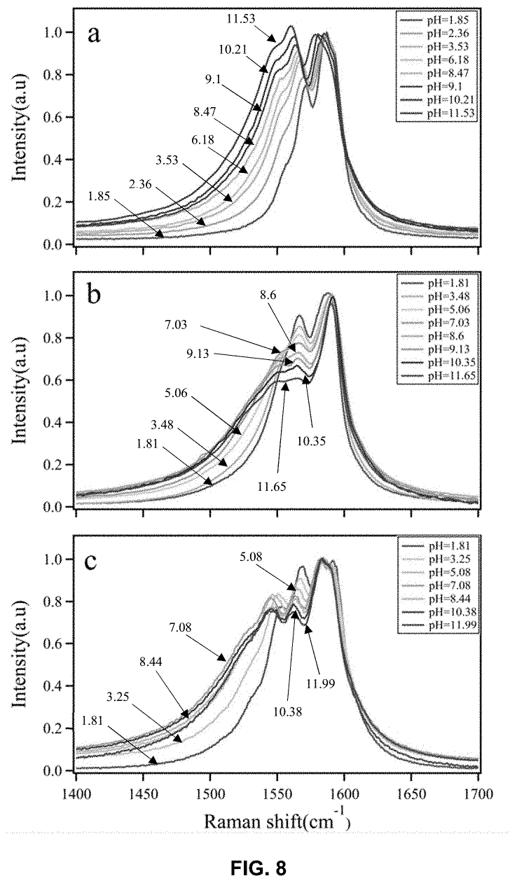

The measurements of the Raman response for each M_{N}-SWCNTs in buffer solutions of constant ionic strength (1 M) at unitary pH increments between 1 to 12 are presented in FIG. 8. While the response of the Ptₙ-SWCNTs is consistent with what is reported above, i.e., SWCNT are undoped at pH=12, the cases of Pd_{N}-SWCNTs and Ru_{N}-SWCNTs appears similarly undoped states at basic pH but behave differently. That is, the slopes of the G₋ mode shift vs. pH is negative for all M_{N}-SWCNTs, but the slopes are smaller for Ru_{N}-SWCNT films and almost none for the Pd_{N}-SWCNT. The mode intensity decreases with pH for both Pd and Ru, while it increases for the Ptₙ-SWCNT. Obviously, these results, when compared to that of the Ptₙ-SWCNTs system, indicate that the Fermi level alignments for both Pd/PdO and Ru/RuO redox couples are different and less favorable for maximum Raman response with pH. The alignments are most likely linked to up shifted potential-pH diagrams of these redox systems. We note that this is probably expected since the workfunction of the metals investigated are much higher for the Pt (i.e. ϕ(Pt)>ϕ(Pd)˜ϕ(Ru)), which imply according to the model that the potential-pH diagrams in FIG. 4 for both metals are shifted up relative to the midgap state of the SWCNTs. While the Raman response with pH is still visible for both Pd and Ru, the signature with pH is broader and more complex in these cases due to potential-pH diagrams overlapping with the n-type doping region of the SWCNTs.

### Example 2

Graphene is a one atom thick material in which all the carbon atoms are at the surface and exposed to the local environment. A graphene layer can therefore interact with ions in solution. It is therefore expected, and observed experimentally, that the properties of graphene are significantly affected by analytes in solution. Similar to the case of carbon nanotubes, this conjuncture along with advances on surface functionalization has stimulated a plethora of studies on the use of graphene for high performance chemical sensors⁵⁸.

Early work on graphene devices have shown that graphene can be doped in solution in two distinct ways: using an applied electric field or by a direct exposure to an adsorbate, which can be either a reductant or an oxidant. On one hand, the electric field doping is generally performed using graphene-field effect transistors (FET), in which charge carriers are induced by establishing an electric potential between the graphene layer and a gate electrode. In air, the concentration of charge carriers can be freely tuned by changing the gate Voltage and measured by the current, but the doping levels obtained are rather low because of the small capacitance of the gate stack, which is generally limited by the oxide thickness and its dielectric constant. Using the FET configuration, it was shown, after many conflicting reports, that graphene transistors are unintentionally p-doped in ambient conditions and additional care must be made to control the initial doping of the graphene⁵⁹. In relation with pH sensing, it was also shown that the graphene itself (i.e., when unfunctionalized) is not sensitive to the pH of the solution⁶⁰. Significantly higher doping levels can be achieved with graphene FET using electrolyte gating, which led to demonstrations of sensing devices in solution operating near the quantum-capacitance limits, with pH detection approaching the Nernstian limit of 55 mV/pH⁶¹. Through surface functionalization, graphene ion sensing FET (ISFET) arrays have shown significant improvement and can provide now selectivity to ion detection near the sensitivity limits of such device of 60 mV per decade at room temperature⁶².

The other form of doping involves charge transfer at the graphene surface, which occurs via a direct interaction between graphene and the adsorbed molecules. When the absorbates participate in an electrochemical redox reaction, higher doping levels than field-effect doping is possible due to significant difference of the chemical potentials of the graphene and molecules, such as hydrazine or 2,3-dichloro-5,6-dicyano-p-benzoquinone (DDQ), in solution⁶³.

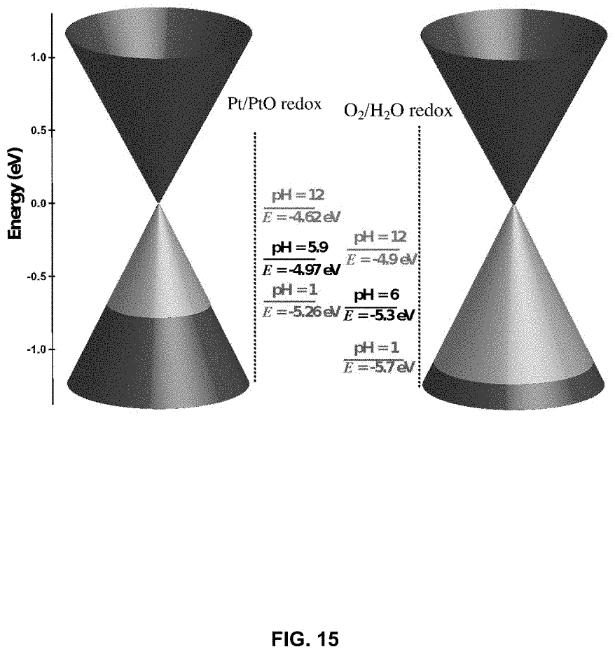

As a good example of the latter, past studies by the present inventors have highlighted the ubiquitous role of the molecules in the environment in graphene p-type doping, which is ascribed to the water/oxygen redox couple⁵⁹. Ambient doping of graphene by the changing the redox potential involves the following equilibrium reaction: O₂(aq)+4 H⁺+4 e⁻(graphene) [symbol] 2 H₂O, which predicts a shift in equilibrium with pH. An example of the Fermi level position of graphene in contact with the O₂/H₂O redox couple in equilibrium conditions at pH=1 is illustrated in FIG. 15 (right). Provided that an oxidized species can be stabilized at the surface of the graphene, this model predicts a strong p-doping of the layer at acidic pH.

Here, the use of graphene instead of carbon nanotubes as a pH sensitive electrode is more specifically explored. This example targets better accuracy for this sensor and aims to deepen further understanding of the Nernstian behavior of the graphene electrode system. Here, it is postulated that a graphene layer when in contact with a Pt/PtO redox couple should exhibit strong pH dependency in aqueous solutions as illustrated in FIG. 15 (left).

Preparation of the Samples

In the experiments, two samples were investigated: uncoated graphene (u-graphene) and platinum coated graphene (Pt-graphene). The latter defines a direct (physical) contact with the Pt/PtO redox couple. The graphene was grown on a copper foil by chemical vapor deposition at 1000° C. using methane as a carbon source and the layer was transferred using Polymethyl methacrylate (PMMA) to a silicon wafer covered with a 300 nm thick oxide layer. The uncoated graphene sample was prepared by removing the PMMA in an acetone bath, followed with drying by IPA (Isopropyl Alcohol vapor drying). The platinum coated graphene sample was prepared the same way as uncoated graphene with an extra step that consisting of coating the surface with a thin layer (˜6 nm) of platinum using e-beam deposition. The Britton-Robinson buffer solutions of constant ionic strength (1 M) were prepared using the standard procedure. Raman spectra were acquired using a custom-built spectrometer equipped with different laser excitation lines (488, 514, 532, and 633 nm) and a nitrogen-cooled silicon detector array (JY Symphony) mounted on a Jobin-Yvon Triax iHR550 spectrometer (grating 1,800 g·mm blazed at 630 nm) with a precision of 0.2 cm⁻¹. The laser power on the sample was kept near 1000 μW and the signal was collected at near-diffraction limited resolution using a 50× objective with a numerical aperture of 0.5. Spectra in solution were acquired in-situ.

Results and Discussion

FIG. 16 presents the Raman spectra at λₑₓ=488 nm in the G-band (1525-1660 cm⁻¹) and D-band (1300-1425 cm⁻¹) regions for both samples, u-graphene and Pt-graphene, in buffer solutions of pH ranging from 1.60 to 11.89. The top and bottom panels present the results for u-graphene and Pt-graphene, respectively. At first sight, the results show strong shifts of the bands with pH for the Pt-graphene sample. Further experiments performed at λₑₓ=514 nm (not shown here) gave the same results except that the signal to noise (S/N) ratio are much lower due to a Raman cross section one thousand times lower than that of carbon nanotubes.

The G-band is a first-order scattering process associated with degenerated phonon modes (iTO and LO) at the Γ point (i.e., at the center of the Brillouin zone). These phonons consist of in-plane vibrations of the sp²-hybridized carbon lattice. In contrast, the D-band and the 2D-band are second-order processes. The D-mode involves light scattering with two iTO phonons near the K point of opposite, yet high, momenta so that the scattering process takes place across the Brillouin zone. All of these modes undergo a blue shift with increasing doping and this surprising behavior has been discussed in the literature. As seen in FIG. 16 for Pt-graphene, a change in pH from 1 to 12 induces a gradual red shift of the D-band and G-band of about 12 cm⁻¹ and 25 cm⁻¹, respectively, whereas the shift of both is generally less than 1 cm⁻¹ for u-graphene. A pH-dependent signature is also noted (not shown here) for the 2D band between 2630 and 2700 cm⁻¹. As per the results with the metallic nanotubes, the shifting trend observed here is consistent with a charge transfer reaction at the surface of the graphene with the protons in the buffer solution. Considering that doping induces a blue shift of the Raman bands, it is possible to deduce that the Pt-graphene appears strongly p-doped at pH=˜1 and its doping level decreases significantly with increasing pH across the whole range. At pH 12, the Raman shift of the G-band is at 1583 cm⁻¹, which indicates that graphene is nearly undoped at this point. The G-band spectra for u-graphene show a slightly blue shifted position at pH=1 near to 1580 cm⁻¹, i.e., weak p-doping, but the graphene remains nearly undoped across the full pH range investigated. The absence of a pH dependency of the Raman bands of u-graphene is not surprising and consistent with earlier results by Schöenberg's group using graphene transistors⁶⁰. The direct comparison between u-graphene and Pt-graphene illustrates well the important role of the surface functionalization with Pt in this doping process.

As shown in the schematic representation of FIG. 15, this electrochemical doping is consistent with a charge transfer between the redox couple in interaction with the graphene electrode. That is, the equilibrium requires that the electrochemical potential of a redox couple, E_{redox}, is aligned with the electrochemical potential of the graphene electrons, which sets the graphene Fermi level, E_{f}. A difference between E_{redox} and E_{f} should drive a charge transfer process between the graphene and the redox couple until the equilibrium is reached between the two systems (i.e., E_{redox}=E_{f}). The case of pH=1 is illustrated in FIG. 15, which predicts a strong p-doping of graphene at this equilibrium position with the redox couples present at the surface (i.e. Pt/PtO and O₂/H₂O redox pairs shown on the left and right panels, respectively). At pH=1, the Pt/PtO system acts as a charge acceptor, which drives the E_{f} of graphene well below the neutrality (or so-called Dirac) point, which is the reference point in the diagram located at zero relative energy. This is in effect a charge transfer from the graphene to the Pt.

As mentioned above, a shift in E_{f} of the graphene causes a blue shift of the Raman G-band and this signal can therefore be used to determine experimentally the doping state of graphene. Assuming that an equilibrium is reached in the solution, one can use the Raman response to probe the potential of the graphene to assess the potential of the solution in the vicinity of the graphene surface. To test the hypothesis of the equilibrium behind the use of the Raman signal as a reference, we have reported in FIG. 17 the fitting results for the D-band (a) and G-band (b) at each pH value for both samples, respectively. The spectra were fit using a Lorentzian function and FIG. 16 reports the peak maxima for each buffer. As seen in FIG. 17b, for Pt-graphene (blue, [symbol] ), the Raman shift of the G-band vs. pH is nearly linear and the slope is −2.4±0.2 cm⁻¹ per pH unit (correlation coefficient is −0.98). This is much steeper than for u-graphene (red, [symbol] ) (−0.13±0.06 cm⁻¹/pH unit), giving about 2 cm⁻¹ shift in total across the range of pH compared to 24 cm⁻¹ for Pt-graphene. The Raman shift with pH of the D-band (FIG. 17a) appears also nearly linear and the slopes are −1.2±0.1 cm⁻¹/pH and −0.12±0.03 cm⁻¹/pH for Pt-graphene and u-graphene, respectively. Overall, the results demonstrate strong doping of the graphene in contact with platinum and that the doping is inversely proportional to the pH of the solution. The u-graphene sample undergoes only a weak p-doping with decreasing pH and it is clear that the graphene itself does not follow the expected equilibrium with the O₂/H₂O redox couple.

The different pH dependencies of the G-band are rationalized by a redox reaction occurring in the environment near the graphene film. An electrochemical charge transfer process at this interface can be used to describe the doping of graphene in a buffer solution. Considering, for instance, a reaction with the O₂/H₂O redox couple using O_{2(aq)}+4H⁺_{(aq)}+4e⁻(graphene) [symbol] 2H₂O_{(I)}, one can infer the energy level (in eV) at equilibrium using the following relationship: E_{abs,O}_{₂}_{/H}_{₂}_{O}=−5.669+0.059·pH (in eV). This gives at equilibrium a Fermi energy position relative to the vacuum level between −5.61 eV and −4.95 eV for pH between 1 and 12, respectively. Considering a work function of roughly 4.6 eV for graphene⁶⁴, the model predicts therefore a strong p-doping of graphene in oxygenated water across the whole range of pH (FIG. 15, right panel). While this model highlights the presence of a driving force for doping with the proton concentration, the results with u-graphene indicate no or little doping dependency with pH, which is inconsistent with the model. The results suggest that the graphene itself does not react with the O₂/H₂O redox couple, at least during the course of the experiment. That is, the u-graphene in solution appears to stay in an out-of-equilibrium state. In fact, previous work from the present inventors has already shown that the charge transfer kinetics takes months before reaching equilibrium⁵⁹. In the experiments, only few minutes elapse between each Raman measurement, which seems far from being enough for achieving equilibrium. Because graphene bares no functional groups and considering that a total of four electrons are needed for this reaction, the surface inertness appears to provide no anchoring for the intermediate species of the reaction. The u-graphene in these experiments is relatively clean and free of surface groups (low Intensity of D band shows low defects on the graphene), which explains why it is a poor redox system for pH sensing.

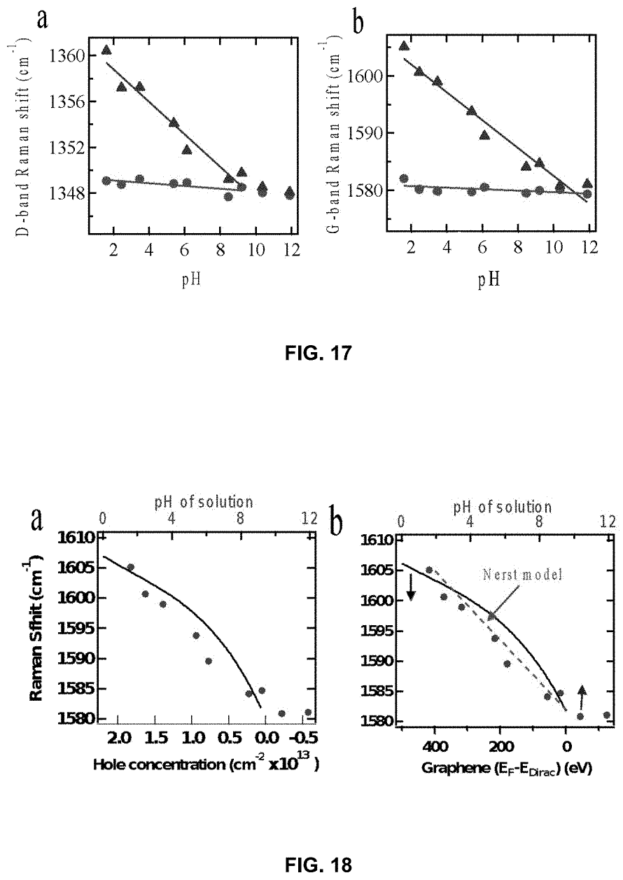

Pt/PtO redox pair solves the surface problem of u-graphene because it can catalyze the redox reaction at its surface and the surface produces stable reduction/oxidation intermediates. When in direct contact with the graphene surface, the Pt/PtO also allows free charge transfer to the graphene until equilibrium is reached between the graphene, the Pt/PtO system and the buffer solution. The Pt coating enables the following redox reaction: PtO+2H⁺+2e⁻(Pt−graphene) [symbol] PtO+H₂O, which can provide a potential energy shift with pH as: E_{abs,Pt/PtO}=−5.32+0.059 pH (in eV). The energy level or Fermi energy of the Pt/PtO at different pH values is between −5.26 eV (pH=1) and −4.62 eV (pH=12), which lies below the graphene work function of 4.6 eV. That is, an acidic solution makes graphene strongly p-doped, whereas a basic solution favors intrinsic graphene, these predictions are quite consistent with the results in FIGS. 17 and 18.

Because the shift of the Raman G-band can probe the carrier concentration, n(E_{F}), in monolayer graphene, one can use calibrated experiments to estimate the carrier concentration in Pt-graphene for each pH experiment. Based on experiments with graphene FETs, Das et al. estimated using the device capacitance a relationship between the G-band position and n(E_{F}) for monolayer graphene⁵⁶. Assuming a linear correlation between the Das results and the pH results in FIG. 16, one can superpose the two experiments together on the same graph as shown in FIG. 18. Interestingly, this comparison shows a fair agreement, suggesting that there is a linear relation between the pH and dopant concentration. Hence, one can use this comparison to determine the Fermi energy in graphene for each n(E_{F}) using

$$n ( {E}_{F} ) = s g n ( {E}_{F} ) \frac{{E}_{F}^{2}}{{π ( {ℏυ}_{F} )}^{2}} ,$$

where υ_{F} is the Fermi velocity (10⁶ m/s) and sgn(E_{F}) is the sign of the Fermi level (negative for hole doping). The resulting values (black curve) are reported in FIG. 18, which compares again the Das results with the experimental results of the Raman G-band shifts vs. pH (blue) for Pt-graphene. Because of the fortuitous linear relationship, one can directly compare these results to estimate the Fermi level position for each pH value of the present Pt-graphene experiments. Interestingly, the model, which predicts a slope of 59 mV/pH for the Nernstian limit (red dotted line), is in a very good agreement with the Raman results obtained here (blue points). It is therefore reasonable to conclude from this simple model that the Pt-graphene surface is at or near equilibrium with the solution. The Raman sensing behavior of Pt-graphene with pH indicates a Nernstian behavior.

Summary of Findings

The Raman response of graphene coated with platinum was characterized in the regions of the G- and D-bands in buffer solutions over a broad range of pH values between 1 to 12. The Raman results are compared to that of uncoated graphene in the same conditions. The uncoated graphene shows small perturbation vs. pH, whereas the Raman spectrum of Platinum decorated graphene undergoes a significant transformation with pH. Increasing the pH induces a linear red shift of both the G- and D-band positions, a phenomenon ascribed to a charge transfer doping. The results are consistent with a redox reaction involving the Pt/PtO redox pair and the proton in the solution. The results indicate that the Pt-graphene electrode is p-doped in acidic pH. Increasing the pH of the solution gradually reduces this hole doping and the graphene becomes intrinsic at pH=12. The linear response observed here in Raman is compared with literature data on graphene FETs. The model shows that the Pt-graphene system follows a Nernstian behavior. While uncoated graphene is to be a bad redox couple for pH measurements, the platinum coated graphene electrode provides a direct measure of the pH of the solution. This work presents Pt coated graphene as a convenient and referenced electrode to sense optically the pH of solutions across a broad range between 1 and 12. These results show that one can prepare graphene based optical pH sensors requiring no electrical contact.

### Example 3

This example provides a novel approach for the synthesis of Pt deposited graphene flakes using wet chemistry.

Materials

Graphene flakes—PureWave Graphene™, were purchased from Raymor Industries Inc., Nanolntegris Technologies Inc. and the material is composed of thin, highly dispersible 1-3 (Mono) or 4-7 (Quattro) layers of turbostratic graphene nanoplatelets with very low oxygen and polyaromatic hydrocarbon (PAH) content.

Sodium dodecyl sulfate (SDS) was purchased from Sigma-Aldrich.

Chloroplatinic acid hydrate (H₂PtCl₆.xH₂O, ≥99.9%) was purchased from Sigma-Aldrich.

A solution of SDS 0.05M was prepared by first dissolving 288 mg of SDS in 10 ml distilled water and then, after dissolution, making up the volume up to 20 ml with distilled water, giving about 1.5% w/v.

5 mg of graphene flakes was dispersed in 20 ml of the SDS solution in a 100 ml round bottom flask. The SDS solution including the graphene flakes was then bath sonicates for about 1 h. Then, 10 mg of chloroplatinic acid hydrate (0.5 ml water solution) was added to the sonicated solution of graphene flakes in the SDS solution and the resulting mixture was sonicated for about 20 minutes. After sonication, the mixture was refluxed at 70 degree Celsius for about 6 h. The solution was then filtered using a 0.2 PTFE filter (membrane). The recovered solid (pellet) was washed by re-dispersing in 15 ml distilled water, sonicating till completely dispersed (approximately 5 minutes) and then filtering again. This “washing” step was repeated 5 times to remove any unreacted platinic salt to result in Pt-coated graphene flakes.

Characterization

The Pt-coated graphene flakes were characterized by TEM. For the TEM analysis, a tiny amount of Pt-coated graphene material was added to 2 ml ethanol and then, the sample was bath sonicated till obtaining a clear solution or complete dispersion. 10 microliters of the resulting sample were added on the TEM grid and left to dry.

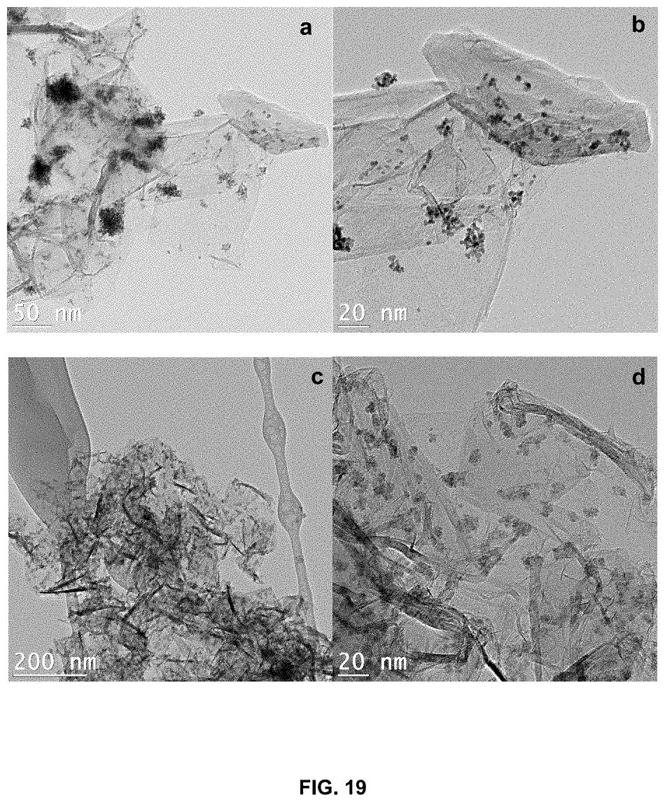

The TEM images are shown in FIG. 19. FIG. 19 shows the comparison between Pt-coated graphene flakes prepared using SDS (c, d) and without using SDS (a, b).

Graphene-Pt prepared without using SDS for the reaction shows aggregation of large Pt island and overall a poor coverage and distribution of Pt clusters. Graphene-Pt prepared using SDS for the reaction shows an improved dispersion of Pt clusters attached to the graphene flakes and substantially no Pt aggregates.

Annex A: Supplemental Information

Amino-Terminated Monolayers on Patterned Silicon Wafers

To help localized the area of Raman analysis, patterned surfaces were prepared using standard photolithography followed by the e-beam evaporation of titanium (5 nm) and platinum (20 nm) on the silicon substrate coated with a 300 nm thick oxide layer (SiO₂). The pattern simplifies the identification of the sample region probed by Raman spectroscopy and allows repeated experiments in the same spot. The patterned substrate was cleaned by sonicating 15 min each in acetone and isopropanol, followed by coating with (3-aminopropryl) triethoxysilane (APTES, 99% purity, Sigma-Aldrich) by reaction of the vapor phase of APTES⁵².

Setup Used for Liquid Measurements in Raman Spectroscopy

The setup used for Liquid Measurements in Raman Spectroscopy is presented in FIG. 9. Raman spectra are collected at room temperature using a laser at a wavelength of 633 nm.

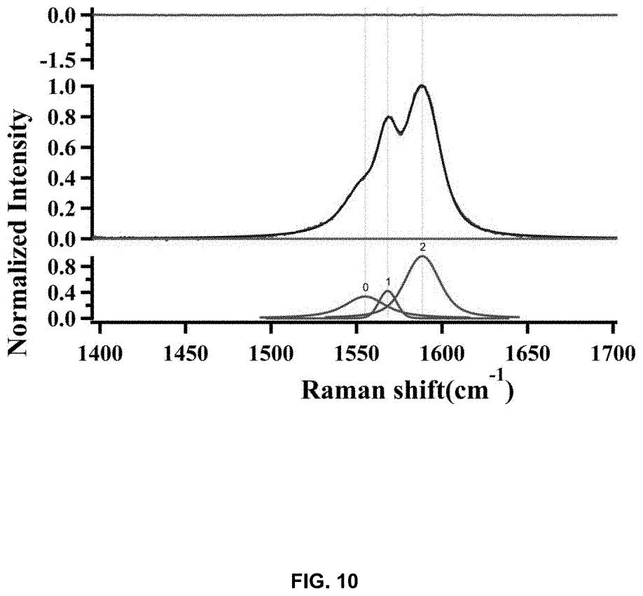

FIG. 10 presents an example of the mathematical deconvolution of the Raman spectrum of a thin film of Pt-coated SWCNT at pH=2.45 (blue line—top curve). The red curves (bottom curves) are the Voigt functions used to fit the three peak components. The peak deconvolution (Voigt function) data of the Raman spectrum are reported in Table S1.

TABLE S1
Example of peak deconvolution (Voigt function) data of the Raman
spectrum of Pt-SWCNTs at pH = 2.45

| Voigt | Location | | | | FWHM* |
|---|---|---|---|---|---|
| function | (cm⁻¹) | Height | Width | Area | (cm⁻¹) |
| Peak0** | 1555 | 1.113 | 0.138 | 14.281 | 28.58 |
| Peak1** | 1568.2 | 0.4524 | 0.144 | 5.5774 | 12.01 |
| Peak2**** | 1588.4 | 1.687 | 0.099 | 30.185 | 23.91 |

*Note:
Full width at half maximum;
**Note:
G_{f} mode;
***Note:
G− mode;
****Note:
G+ mode

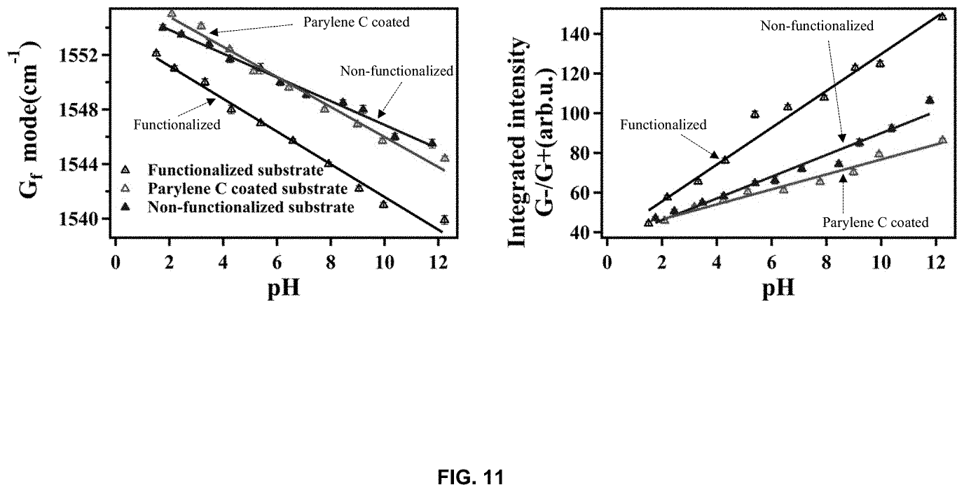

FIG. 11 shows the Raman shift of the G_{f} mode and the I(G₋/G₊) ratio, i.e. the normalized integrated intensity of the G₋ mode relative to the G₊ mode, of Pt-SWCNTs in buffer solutions of constant ionic strength (1 M) with three different substrates (aminopropyl-silanized, non-silanized, and parylene C-coated silicon/silicon oxide wafer).

Effect of the Internal Stress of Parylene C Layer-Coated Silicon Wafer on the Raman Spectra

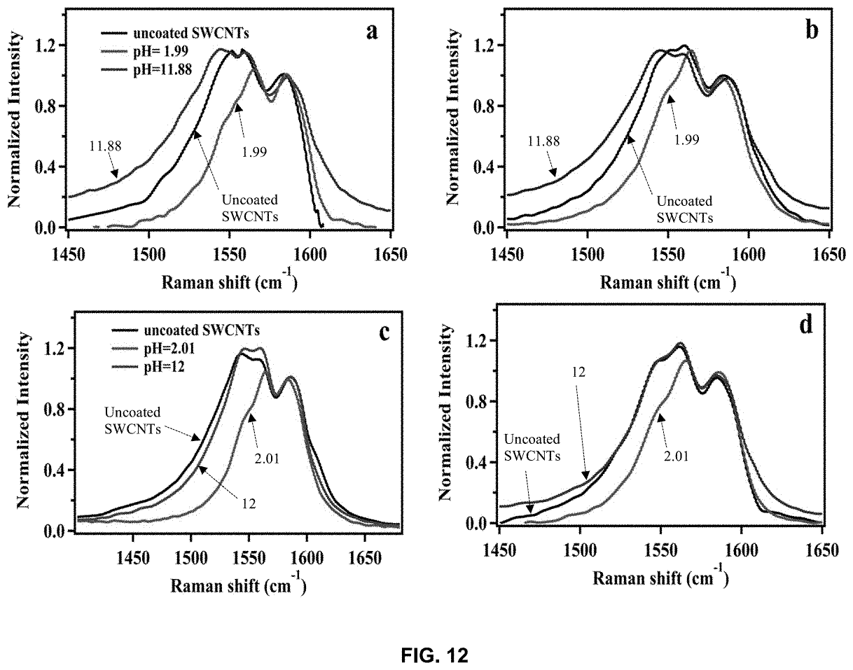

The poor adhesion of films of SWCNTs to parylene C-coated substrates using the transfer technique can be a source of internal stress⁵³. The presence of stress is shown in FIG. 12. The Raman spectra acquired in two different spots of uncoated SWCNTs in the dry state (FIG. 12a,b) give bands with different positions. Many reports suggest that annealing the substrate can reduce stress as it recrystallizes the parylene interfaces^{54,4}. Hence, the sample was annealed at 300° C. under vacuum to remove this internal stress and the results are shown in FIG. S4c,d. The Raman spectra of uncoated SWCNTs in the dry state are overlaid on those of the sample in the buffer solution at two different pH values (pH=2.01 and pH=12.00).

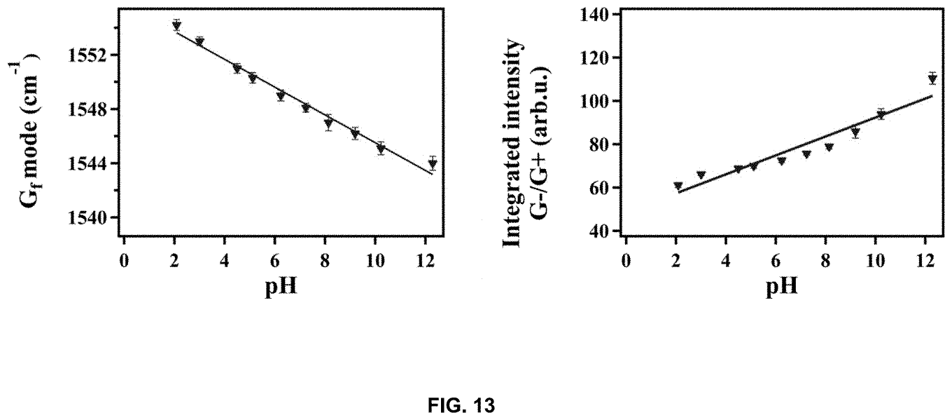

FIG. 13 shows the variations of the Raman shift of the G_{f} mode and the I(G₋/G₊) ratio, i.e. the normalized integrated intensity of the G-mode relative to the G₊ mode, of Pt_{N}-SWCNTs vs pH at constant ionic strength (1 M).

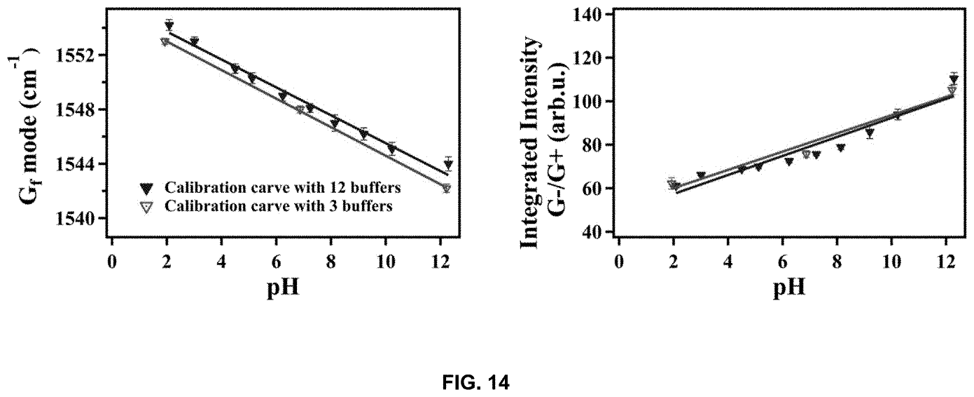

FIG. 14 shows the calibration curves based on the Raman shifts of the G_{f} mode and the I(G₋/G₊) ratio, i.e. the normalized integrated intensity of the G₋ mode relative to the G₊ mode, of Pt_{N}-SWCNTs versus pH using solutions of 12 buffers (blue, [symbol] ) and 3 buffers (red, [symbol] ).

Calculations of the Uncertainty on the pH Values Determined from the Raman Shifts and Intensities

A linear regression using y(Raman-shift)=b·(pH)+a, where a and b are fitting parameters, was performed using the standard curves with different buffers (FIG. 7d). One can determine from the Raman shift the pH value using: pH=[y(Raman-shift)−a]/b. The fitting parameters a and b are given for each calibration curve under the Tables for each parameter extracted, G₋ (Table S2), G_{f} (Table S3) or I(G₋/G₊) (Table S5). The Raman parameters, G₋, G_{f}, and I(G₋/G₊), for each unknown solution with the associated standard deviation are given is Table S2, Table S4 and Table S6, respectively. The uncertainty on the pH is therefore obtained using

$$\frac{ΔpH}{pH} = \frac{( {Δ}_{y} + Δ a )}{\vert y - a \vert} + \frac{Δ b}{\vert b \vert} .$$

TABLE S2
Raman shift of the G− mode repeated at different spots for each unknown
sample; standard deviation and mean of the Raman shifts as well as pH
measured using a conventional pH meter.

| | Raman shift | |
|---|---|---|
| | G− mode | |
| pH | (cm⁻¹) in | Standard Deviation (SD) |
| (results from pH meter) | different spots | Mean of data (Mean) |
| 4.80 ± 0.01 | 1566.2 | Mean = 1566.1 |
| (I = 1M) | 1565.8 | SD = 0.2 |
| | 1565.9 | |
| | 1566.3 | |
| | 1566.2 | |
| 11.80 ± 0.01 | 1561.1 | Mean = 1561.1 |
| (I = 1M) | 1561.1 | SD = 0.1 |
| | 1561 | |
| | 1560.9 | |
| | 1561.2 | |
| 4.50 ± 0.01 | 1566.1 | Mean = 1566.1 |
| | 1566.3 | SD = 0.1 |
| | 1566.2 | |
| | 1566.1 | |
| | 1566 | |
| 11.00 ± 0.01 | 1561.8 | Mean = 1561.6 |
| | 1561.7 | SD = 0.1 |
| | 1561.6 | |
| | 1561.5 | |
| | 1561.6 | |

TABLE S3
pH value of unknown samples (at constant and non-constant ionic
strength) with different calibration curves using the Raman shift of the
G_{f} mode.

| | | pH** |
|---|---|---|
| pH | pH * | Pt_{N}-SWCNTs |
| Conventional meter | Pt_{N}-SWCNTs (3 buffers) | (12 buffers) |
| 4.80 ± 0.01 | 4.0 ± 0.5 | 4.8 ± 0.5 |
| (I = 1M) | | |
| 11.80 ± 0.01 | 11.1 ± 0.6 | 12.0 ± 0.8 |
| (I = 1M) | | |
| 4.50 ± 0.01 | 3.3 ± 0.4 | 4.1 ± 0.5 |
| 11.00 ± 0.01 | 10.2 ± 0.6 | 11.1 ± 0.8 |

* Error obtained using the calibration curve with 3 buffers: a = 1555.1 ± 0.2; b = −1.05 ± 0.02
** Error obtained using the calibration curve with 12 buffers: a = 1555.8 ± 0.3; b = −1.03 ± 0.05

TABLE S4
Raman shift of the G_{f} mode repeated at different locations of each
test sample. Standard deviation, and mean of the Raman shifts as well
as the pH measured using a conventional pH meter.

| pH | Raman shift of | Standard Deviation and |
|---|---|---|
| pH meter | G_{f} band (cm⁻¹) | Mean of data |
| 4.80 ± 0.01 | 1550.7 | Mean = 1550.9 |
| (I = 1M) | 1551.2 | SD = 0.2 |
| | 1551 | |
| | 1550.8 | |
| | 1551 | |
| 11.80 ± 0.01 | 1543.5 | Mean = 1543.4 |
| (I = 1M) | 1543.4 | SD = 0.1 |
| | 1543.3 | |
| | 1543.2 | |
| | 1543.5 | |
| 4.50 ± 0.01 | 1551.8 | Mean = 1551.6 |
| | 1551.7 | SD = 0.1 |
| | 1551.5 | |
| | 1551.6 | |
| | 1551.5 | |
| 11.00 ± 0.01 | 1544.4 | Mean = 1544.4 |
| | 1544.3 | SD = 0.1 |
| | 1544.5 | |
| | 1544.3 | |
| | 1544.6 | |

TABLE S5
pH value of unknown samples at constant (1M) and non-constant ionic
strengths using different calibration curves and the variation of
I(G−/G+), i.e. the integrated intensity of the G− mode normalized
with the G+ mode.

| | | pH ** |
|---|---|---|
| pH | pH * | Pt_{N}-SWCNTs |
| Conventional pH meter | Pt_{N}-SWCNTs (3 buffers) | (12 buffers) |
| 4.8 ± 0.01 | 4 ± 2 | 5 ± 2 |
| (I = 1M) | | |
| 11.8 ± 0.01 | 12 ± 4 | 12 ± 3 |
| (I = 1M) | | |
| 4.5 ± 0.01 | 4 ± 2 | 4 ± 2 |
| 11.0 ± 0.01 | 11 ± 3 | 11 ± 3 |

* Error obtained using the calibration curve with 3 buffers: a = 52 ± 7; b = 4.2 ± 0.8
** Error obtained using the calibration curve with 12 buffers: a = 49 ± 4; b = 4.4 ± 0.5

TABLE S6
The I(G−/G+) ratio, i.e. the integrated Intensity of normalized
G− mode relative to G+ mode, standard deviation and
mean of data for solutions of different pH as well as the pH
measured using a conventional pH meter.

| | | Mean of data (Mean) |
|---|---|---|
| pH | Normalized I(G−/G+) | Standard Deviation |
| (results from pH meter) | (different spots) | (SD) |
| 4.80 ± 0.01 | 69.2 | Mean = 69.1 |
| (I = 1M) | 68.8 | SD = 0.8 |
| | 68.3 | |
| | 70.4 | |
| | 68.9 | |
| 11.80 ± 0.01 | 101.7 | Mean = 101 |
| (I = 1M) | 97.3 | SD = 3 |
| | 102.4 | |
| | 103.9 | |
| | 99.2 | |
| 4.50 ± 0.01 | 69.4 | Mean = 68.5 |
| | 68.6 | SD = 0.9 |
| | 69.1 | |
| | 68.1 | |
| | 67.2 | |
| 11.00 ± 0.01 | 95.1 | Mean = 97 |
| | 99.3 | SD = 3 |
| | 94.6 | |
| | 96.7 | |
| | 100.1 | |

### REFERENCES

(1) Wang, L.; et al. Imaging acidosis in tumors using a pH-activated near-infrared fluorescence probe. Chem. Commun. 2012, 48, 11677-11679.

(2) Sawyer, R. G.; Spengler, M. D.; Adams, R. B.; Pruett, T. L. The peritoneal environment during infection. The effect of monomicrobial and polymicrobial bacteria on pO₂ and pH. Anal. Surg. 1991, 213, 253-260.

(3) Schreml, S.; et al. The impact of the pH value on skin integrity and cutaneous wound healing. J. Eur. Acad. Dermatol. Venereol. 2010, 24, 373-378.

(4) Lauvset, S. K.; et al. Trends and drivers in global surface ocean pH over the past 3 decades. Biogeosciences. 2015, 12, 1285-1298.

(5) Friedrich, T.; et al. Detecting regional anthropogenic trends in ocean acidification against natural variability. Nat. Clim. Change 2012, 2, 167-171.

(6) Slessarev, E. W.; Lin, Y.; Bingham, N. L.; Johnson, J. E.; Dai, Y.; Schimel, J. P.; Chadwick, O. A. Water balance creates a threshold in soil pH at the global scale, Nature. 2016, 540, 567-569.

(7) Duncan, T. V.; Applications of nanotechnology in food packaging and food safety: Barrier materials, antimicrobials and sensors, J. Colloid Interface Sci. 2011, 363, 1.

(8) Pacquit, A.; Frisby, J.; Diamond, D.; Lau, K. T.; Farrell, A.; B. Quilty and D. Diamond, Development of a smart packaging for the monitoring of fish spoilage, Food Chem. 2007, 102, 466.

(9) Skoog, D. A., Holler, F. J. and Crouch, S. R.; Principles of Instrumental Analysis 6^{th} edn, Thomson Brooks/Cole Publishing: Belmont, Calif., 2007; pp 689-690.

(10) Bergveld, P. Thirty years of ISFETOLOGY: What happened in the past 30 years and what may happen in the next 30 years. Sens. Actuators. 2003, 88, 1-20.

(11) Liu, Y. S.; Sun, Y.; Vernier, P. T.; Liang, C. H.; Chong, S. Y. C.; Gundersen, M. A. pH-sensitive photoluminescence of CdSe/ZnSe/ZnS quantum dots in human ovarian cancer cells. J. Phys. Chem. C 2007, 111, 2872-2878.

(12) Han, J.; Burgess, K. Fluorescent Indicators for Intracellular pH. Chem. Rev. 2010, 110, 2709-2728.

(13) Wu, W.; Shen, J.; Banerjee, P.; Zhou, S. Chitosan-based responsive hybrid nanogels for integration of optical pH-sensing, tumor cell imaging and controlled drug delivery. Biomaterials, 2010, 31, 8371-8381.

(14) Safavi, A.; Abdollahi, H. Optical sensor for high pH values. Anal. Chim. Acta, 1998, 367, 167-173.

(15) Pietsch, C.; Hoogenboom, R.; Schubert, U. S. Soluble polymeric dual sensor for temperature and pH value. Angew. Chem. 2009, 121, 5763-5766.

(16) Ferrer-Anglada, N.; Kaempgen, M.; Roth, S. Transparent and flexible carbon nanotube/polypyrrole and carbon nanotube/polyaniline pH sensors. Phys. Stat. Sol., 2006, 13, 3519-3523.

(17) Zong, Z.; Xu, M.; Xu, L. J.; Wei, T.; Ma, X.; Zheng, X. S.; Hu, R.; Ren, B. Surface-Enhanced Raman Spectroscopy for Bioanalysis: Reliability and Challenges. Chem. Rev. 2018, 118, 4946-4980.

(18) Dresselhaus, M. S.; Dresselhaus, G.; Jorio, A. Raman spectroscopy of carbon nanotubes in 1997 and 2007. J. Phys. Chem. C 2007, 111, 17887-17893.

(19) Barone, P. W.; Baik, S.; Heller, D. A.; Strano, M. S. Near-infrared optical sensors based on single-walled carbon nanotubes. Nat. Mater. 2004, 4, 86-92.

(20) Balasubramanian, K.; Burghard, M. Biosensors Based on Carbon Nanotubes. Anal. Bioanal. Chem. 2006, 385, 452-468.

(21) Heller, D. A.; Jeng, E. S.; Yeung, T. K.; Martinez, B. M.; Moll, A. E.; Gastala, J. B.; Strano, M. S. Optical detection of DNA conformational polymorphism on single-walled carbon nanotubes. Science 2006, 311, 508-511.

(22) Gaufrès, E.; Marcet, S.; Aymong, V.; Tang, N. Y. W.; Favron, A.; Thouin, F.; Allard, C.; Rioux, D.; Cottenye, N.; Verhaegen, M.; Martel, R. Hyperspectral Raman Imaging Using Bragg Tunable Filters of Graphene and Other Low-Dimensional Materials. J. Raman Spectrosc. 2018, 49 (1), 174-182.

(23) Rao, A. M.; Eklund, P. C.; Bandow, S.; Thess, A.; Smalley, R. E. Evidence for Charge Transfer in Doped Carbon Nanotube Bundles from Raman Scattering. Nature, 1997, 388, 257-259.

(24) Petit, P.; Mathis, C.; Journet, C.; Bernier, P. Tuning and Monitoring the Electronic Structure of Carbon Nanotubes. Chem. Phys. Lett. 1999, 305, 370-374.

(25) Jouguelet, E.; Mathis, C.; Petit, P. Controlling the electronic properties of single-wall carbon nanotubes by chemical doping. Chem. Phys. Lett. 2000, 318, 561.

(26) Tsang, J. C.; Freitag, M.; Perebeinos, V.; Liu, J.; Avouris, P. Doping and phonon renormalization in carbon nanotubes. Nat. Nanotechnol. 2007, 2, 725-730.

(27) Anglaret, E.; Dragin, F.; Pénicaud A.; Martel R., Raman studies of single-wall carbon nanotube salts in solutions, J. Phys. Chem. B, 2006, 110, 3949-3954.

(28) Kingston, C. T.; Jakubek, Z. J.; Dénommée, S.; Simard, B. Efficient Laser Synthesis of Single-Walled Carbon Nanotubes through Laser Heating of the Condensing Vaporization Plume. Carbon, 2004, 42, 1657.

(29) Kataura, H.; Kumazawa, Y.; Maniwa, Y.; Umezu, I.; Suzuki, S.; Ohtsuka, Y.; Achiba, Y. Optical Properties of Single-Wall Carbon Nanotubes. Synthetic Metals. 1999, 103, 2555-2558.

(30) Zhang, L.; Huang, L.; O'Brien, S. P.; Yu, Z.; Electrostatic doping-induced phonon shift of metallic single-wall carbon nanotubes. J. Phys. Chem. C, 2008, 112, 20118-22.

(31) Dubay, O.; Kresse, G.; Kuzmany, H. Phonon Softening in Metallic Nanotubes by a Peierls-like Mechanism. Phys. Rev. Lett. 2002, 88, 235506.

(32) Wu, Y.; Maultzsch, J.; Knoesel, E.; Chandra, B.; Huang, M. Y.; Sfeir, M. Y.; Brus, L. E.; Hone, J.; Heinz, T. F. Variable Electron-Phonon Coupling in Isolated Metallic Carbon Nanotubes Observed by Raman Scattering. Phys. Rev. Lett.2007, 99, 027402.

(33) Lazzeri, M.; Piscanec, S.; Mauri, F.; Ferrari, A. C.; Robertson, J. Phonon linewidths and electron-phonon coupling in graphite and nanotubes. Phys. Rev. B 2006, 73, 155426-155431.

(34) Lazzeri, M.; Mauri, F. Nonadiabatic Kohn Anomaly in a Doped Graphene Monolayer. Phys. Rev. Lett. 2006, 97, 266407.

(35) Yan, J.; Zhang, Y.; Kim, P.; Pinczuk, A. Electric Field Effect Tuning of Electron-Phonon Coupling in Graphene. Phys. Rev. Lett. 2007, 98, 166802/1-166802/4.

(36) Zhang, L.; Liao, V.; Yu, Z. Raman spectroelectrochemistry of a single-wall carbon nanotube bundle, Carbon, 2010, 48, 2582.

(37) Gao, Y. Q.; Georgievskii, Y.; Marcus, R. A. On the Theory of Electron Transfer Reactions at Semiconductor Electrode/Liquid Interfaces. J. Chem. Phys. 2000, 112, 3358-3369.

(38) Marcus, R. A. On the Theory of Oxidation-Reduction Reactions Involving Electron Transfer. J. Chem. Phys. 1956, 24, 966.

(39) Aguirre, C. M.; Levesque, P. L.; Paillet, M.; Lapointe, F.; St-Antoine, B. C.; Desjardins, P.; Martel, R. The Role of the Oxygen/Water Redox Couple in Suppressing Electron Conduction in Field-Effect Transistors. Adv. Mater. 2009, 21, 3087-3091.

(40) Chakrapani, V.; et al. Charge transfer equilibria between diamond and an aqueous oxygen electrochemical redox couple. Science, 2007, 318, 1424-1430.

(41) Zambelli, T.; Barth, J. V.; Wintterlin, J.; Ertl, G. Catalytic oxidation of carbon monoxide on monodispersed platinum clusters: each atom counts. Nature, 1997, 390, 495-497.

(42) Cherevko, S.; Zeradjanin, A. R.; Keeley, G. P.; Mayrhofer, K. J. J. A Comparative Study on Gold and Platinum Dissolution in Acidic and Alkaline Media, J. Electrochem. Soc. 2014, 161, H822-H830.

(43) Yuan, X-Z.; Wang, H. PEM Fuel Cell Fundamentals. In PEM Fuel Cell Electrocatalysts and Catalyst Layers; Zhang, J., Eds.; Springer: London, 2008; pp 1-87.

(44) Kazaoui, S., Minami, N., Matsuda, N., Kataura, H., and Achiba, Y. Electrochemical tuning of electronic states in single-wall carbon nanotubes studied by in situ absorption spectroscopy and ac resistance, Appl. Phys. Lett. 2001, 78, 3433.

(45) Mongay, C.; Cerda, V. Britton-Robinson buffer of known ionic strength. Ann. Chim. (Rome, Italy) 1974, 64, 409-412.

(46) Dresselhaus, M. S. Solid State Physics Part II Optical Properties of Solids; Oxford University Press: 2001.

(47) Sulpizi, M.; Gaigeot, M.-P.; Sprik, M. The Silica-Water Interface: How the Silanols

Determine the Surface Acidity and Modulate the Water Properties, J. Chem. Theory Comput. 2012, 8, 1037.

(48) Bishnoi, S. W.; Rozell, C. J.; Levin, C. S.; Gheith, M. K.; Johnson, B. R.; Johnson, D. H.; Halas, N. J. All-Optical Nanoscale pH Meter, Nano Lett. 2006, 6, 1687.

(49) Gotor, R.; Ashokkumar, P.; Hech, M.; Keil, K.; Rurack, K. Optical pH Sensor Covering the Range from pH 0-14 Compatible with Mobile-Device Readout and Based on a Set of Rationally Designed Indicator Dyes. Anal. Chem. 2017, 89, 8437.

(50) Wang, L.; Li, M.; Li, W.; Han, Y.; Liu, Y.; Li, Z.; Zhang, B.; Pan, D. Rationally Designed Efficient Dual-Mode Colorimetric/Fluorescence Sensor Based on Carbon Dots for Detection of pH and Cu2+ Ions. ACS Sustainable Chem. Eng. 2018, 6 (10), 12668-12674.

(51) Fakih, I.; Mahvash, F.; Siaj, M.; Szkopek, T. Sensitive Precise pH Measurement with Large-Area Graphene Field-Effect Transistors at the Quantum-Capacitance Limit. Phys. Rev. Appl. 2017, 8, 044022.

(52) Gaufres, E.; Tang, N. Y.; Lapointe, F.; Cabana, J.; Nadon, M.-A.; Cottenyel, N.; Raymond, F.; Szkopek, T.; Martel, R. Giant Raman scattering from J-aggregated dyes inside carbon nanotubes for multispectral imaging, Nature Photonics, 2014, 8, 73-79.

(53) Ortigoza-Diaz, J.; et al. Techniques and Considerations in the Microfabrication of Parylene C Microelectromechanical Systems, Micromachines, 2018, 9, 422-447.

(54) Patrick von Metzen, R.; Stieglitz, T.; The effects of annealing on mechanical, chemical, and physical properties and structural stability of Parylene C, Biomed. Microdevices, 2013, 15, 727-735.

(55) Davis, E. M.; Benetatos, N. M.; Regnault, W. F.; Winey, K. I.; Elabd, Y. A. The influence of thermal history on structure and water transport in Parylene C coatings. Polymer, 2011, 52, 5378-5386.

(56) Das, A.; Pisana, S.; Chakraborty, B.; Piscanec, S.; Saha, S. K.; Waghmare, U. V.; Novoselov, K. S.; Krishnamurthy, H. R.; Geim, A. K.; Ferrari, A. C., Monitoring dopants by Raman scattering in an electrochemically top-gated graphene transistor. Nat. Nanotechnol. 2008, 3 (4), 210-215.

(57) Aguirre, C. M.; Levesque, P. L.; Paillet, M.; Lapointe, F.; St-Antoine, B. C.; Desjardins, P.; Martel, R., The role of the oxygen/water redox couple in suppressing electron conduction in field-effect transistors. Adv. Mater. 2009, 21 (30), 3087-3091.

(58) Zubiarrain-Laserna, A.; Kruse, P., Graphene-Based Water Quality Sensors. J. Electrochem. Soc. 2020, 167 (3), 037539.

(59) Levesque, P. L.; Sabri, S. S.; Aguirre, C. M.; Guillemette, J.; Siaj, M.; Desjardins, P.; Szkopek, T.; Martel, R., Probing charge transfer at surfaces using graphene transistors. Nano lett. 2011, 11 (1), 132-137.

(60) Fu, W.; Nef, C.; Knopfmacher, 0.; Tarasov, A.; Weiss, M.; Calame, M.; Schönenberger, C. Graphene Transistors Are Insensitive to pH Changes in Solution. Nano Lett. 2011, 11, 3597-3600

(61) Shan, X. N.; Chen, S.; Wang, H.; Chen, Z. X.; Guan, Y.; Wang, Y. X.; Wang, S. P.; Chen, H. Y.; Tao, N. J. Mapping Local Quantum Capacitance and Charged Impurities in Graphene via Plasmonic Impedance Imaging. Adv. Mater. 2015, 27, 6213-6219

(62) Fakih, I.; Durnan, O.; Mahvash, F.; Napal, I.; Centeno, A.; Zurutuza, A.; Yargeau, V.; Szkopek, T., Selective ion sensing with high resolution large area graphene field effect transistor arrays. Nat. Commun. 2020, 11 (1), 1-12.

(63) Sque, S. J.; Jones, R.; Briddon, P. R., The transfer doping of graphite and graphene. Phys. Status Solidi 2007, 204 (9), 3078-3084

(64) Barone, V.; Hod, O.; Scuseria, G. E., Electronic structure and stability of semiconducting graphene nanoribbons. Nano lett. 2006, 6 (12), 2748-2754.

1. A pH responsive optical nanoprobe, comprising metallic Single Wall Carbon Nanotubes (SWCNTs) or graphene coated with a transition metal M, thereby defining M-SWCNTs or M-graphene, wherein the M-SWCNTs or the M-graphene have an absorption spectrum comprising an optical resonance, and have a Raman scattering spectrum responsive to optical excitation at said optical resonance comprising at least one pH-dependent peak having at least one of a Raman shift value and an intensity that is function of a solution pH, when the nanoprobe is in contact with a solution at said solution pH.

2. The pH responsive optical nanoprobe according to claim 1, wherein the Raman shift and/or the intensity of the at least one pH-dependent peak varies substantially linearly with said solution pH.

3. The pH responsive optical nanoprobe according to claim 1, wherein the Raman scattering spectrum responsive to optical excitation at said resonance extends with a G band region.

4. The pH responsive optical nanoprobe according to claim 3, wherein the G band region comprises Raman shift values between about 1450 cm⁻¹ and about 1650 cm⁻¹.

5. The pH-responsive optical probe according to claim 4, wherein the nanoprobe comprises metallic SWCNTs and the at least one pH-dependent peak comprises a G₋ mode peak associated with a LO phonon branch of the metallic SWCNTs.

6. The pH-responsive optical probe according to claim 3, wherein the nanoprobe comprises metallic SWCNTs and the at least one pH-dependent peak comprises a G_{f} mode peak associated with an anomaly of the band structure of the metallic SWCNTs.

7. The pH responsive optical nanoprobe according to claim 3, wherein the nanoprobe comprises metallic SWCNTs and the Raman scattering spectrum responsive to optical excitation at said optical resonance of the metallic SWCNTs further comprises at least one pH-independent peak being a G₊ mode peak, at a Raman shift substantially insensitive to the solution pH.

8. The pH responsive optical nanoprobe according to claim 1, wherein the SWCNTs have a diameter distribution of from about 0.4 nm to about 3 nm.

9. The pH responsive optical nanoprobe according to claim 1, wherein the nanoprobe comprises graphene layers and/or graphene flakes.

10. The pH responsive optical nanoprobe according to claim 1, wherein the metallic SWCNTs or the graphene are coated with transition metal-based nanoparticles having a particle size distribution of from about 0.9 nm to about 500 nm.

11. The pH responsive optical nanoprobe according to claim 10, wherein the transition metal-based nanoparticles have a particle size distribution of from about 0.9 to about 20 nm.

12. The pH responsive optical nanoprobe according to claim 1, wherein the metallic SWCNTs or the graphene are coated with a thin film comprising the transition metal and the film has a thickness of from about 0.7 to about 300 nm.

13. The pH responsive optical nanoprobe according to claim 1, wherein the metallic SWCNTs or the graphene are coated with Pt, W, Pd, Ir or Ru or any alloy thereof and/or an oxide thereof.

14. The pH responsive optical nanoprobe according to claim 1, wherein the transition metal comprises Pt.

15. The pH responsive optical nanoprobe according to claim 1, wherein the M-SWCNTs or M-graphene are in a powder form and the powder is dispersed or encapsulated in a porous transparent material.

16. The pH responsive optical nanoprobe according to 1, wherein the solution is an aqueous solution.

17. A method for preparing graphene or SWCNTs coated with transition metal-based nanoparticles, comprising:
preparing a dispersion comprising individualized graphene or SWCNTs comprising metallic SWCNTs;
adding a salt of the transition metal to the dispersion to form a mixture;
heating the mixture;
filtering or centrifuging the mixture to recover the coated graphene or SWCNTs
washing the coated graphene or SWCNTs with water to remove any unreacted metal salt;
drying the coated graphene or SWCNTs.

18. The method according to claim 17, wherein preparing the dispersion comprising individualized graphene or SWCNTs comprises sonicating an aqueous solution of the graphene or SWCNTs in the presence of a surfactant comprising sodium dodecyl sulfate (SDS), sodium cholate or a mixture thereof.

19. The method according to claim 17, wherein the salt is a Pt salt comprising H₂PtCl₆, PtCl₂, PtBr₂, PtCl₃, PtBr₃, PtI₂, PtSO₄, PtCl₂(NH₄)₂, [Pt(NH₃)₂]Cl₄ or any mixture thereof.

20. A method for measuring the pH of a solution, comprising:
contacting the solution with a pH responsive optical nanoprobe according to claim 1;
illuminating the pH responsive optical nanoprobe with an excitation light beam having a wavelength at said optical resonance, thereby generating a Raman signal from said pH responsive nanoprobe according to said Raman scattering spectrum;
measuring a spectral distribution and intensity of the Raman signal;
determining the pH of the solution from said spectral distribution and intensity.
